(19) United States
(12) Patent Application Publication
(10) Pub. No.: US 2010/0306128 A1
(43) Pub. Date: Dec. 2, 2010

(54) SECURITIES' VALUE MONITOR PROGRAM

(75) Inventors: David K. Moffat, Media, PA (US); Kenneth J. Evola, Oakton, VA (US); Greg W. Naviloff, Milton, MA (US)

Correspondence Address: BARNES & THORNBURG LLP, 600 ONE SUMMIT SQUARE, FORT WAYNE, IN, 46802, US

(73) Assignee: HURON CONSULTING GROUP, CHICAGO, IL (US)

(21) Appl. No.: 12/714,701

(22) Filed: Mar. 1, 2010

Related U.S. Application Data
(60) Provisional application No. 61/156,097, filed on Feb. 27, 2009.

(51) Int. Cl. G06Q 40/00

(52) U.S. Cl. 705/36 R

(57) ABSTRACT

An illustrative embodiment of the present disclosure includes a computer-based method to enable users to comparatively monitor a fair value for a security. The method comprises the steps of: providing a computer configured to receive a data file of securities information wherein computer performs the steps of: uploading a data file of securities information; merging the data with corresponding data provided by other contributors relevant to the security; analyzing the merged data to create key performance indicators; creating a data table of securities from the data files uploaded to the computer; filtering out identities of names of contributors to keep source of securities pricing information anonymous; calculating percentage of contributors who have selected SFAS 157 Levels other than the SFAS 157 Level disclosed in the upload; selectively creating a report; and comparing user price paid to other valuations to gauge whether the particular valuation is a fair value.

### RELATED APPLICATIONS

The present application is related to and claims priority to U.S. Provisional Patent Application Ser. No. 61/156,097, filed on Feb. 27, 2009, entitled Fair Value Monitor Program. The subject matter disclosed in that provisional application is hereby expressly incorporated into the present application.

### TECHNICAL FIELD AND SUMMARY

The present disclosure relates to a computerized investment tool for securing anonymous pricing information for a variety of securities including those that are difficult to assign a value. Securities are investments like stocks, bonds, and limited partnership interests, just to name a few. This system assists in valuing securities to support the reasonableness of the valuations obtained from broker quotes, pricing services, or evaluation models. A particular valuation in this program is statistically compared to other valuations based on direct and dollar-weighted benchmarks, for example, to determine whether the particular valuation is fair.

When evaluating assets, the historical paradigm was to bring the price paid to a vendor to get an aggregate price and then wonder if it was right. The aggregate price did not necessarily represent a real cross-section of prices being paid for particular assets, rather merely a best guess. Vendors just did not have that kind of information, so one could only speculate. That is to say, pricing was more a leap of faith than an objectively-based analysis.

An illustrative embodiment of the present disclosure includes a computer-based method to enable users to comparatively monitor a fair value for a security. The method comprises the steps of: providing a computer configured to receive a data file of securities information that includes identity of security, identifier, market value, and par value/shares, SFAS 157 Level disclosure from a network. The computer performs the steps of: verifying the data file to confirm proper type of characters in each field of the data file are being used, pricing being limited to a predetermined date range, no zero or null values in each field, and reviewing outlier data; displaying a warning for rejected data and acceptance notice for accepted data; uploading accepted data from the data file to the computer; merging accepted data from the data file with corresponding data provided by other contributors relevant to the security to create merged data; displaying a notice when merging is complete; analyzing the merged data to create key performance indicators including absolute price deviation, standard deviation, minimum price, maximum price, mean price, median price, 2 sigma low, 2 sigma high, and 1 standard deviation; creating a data table of securities from the data files uploaded to the computer, wherein the data table identifies the number of other contributors, SFAS 157 Level, SFAS 157 deviation, and key performance indicators; filtering out identities of names of contributors to keep source of securities pricing information anonymous; calculating percentage of contributors who have selected SFAS 157 Levels other than the SFAS 157 Level disclosed in the upload; selectively creating a report selected from a group consisting of deviations, price and markets, and analysis; wherein the deviations report comprises statistical fair value evaluation, SFAS 157 Level, and trend analysis categories; wherein the prices and markets report comprises market value by product type, regional breakdown, and contributor type categories; wherein the analysis report comprises default analysis and customizable value analysis categories; creating user-manipulable reports from the key performance indicators; and comparing user price paid to other valuations to gauge whether the particular valuation is a fair or reasonable value.

In the above and other illustrative embodiments, the method comprises the further steps of: the resulting data table including a listing of securities submitted by others that is more than 2% greater than a weighted average mean of prices uploaded by other contributors; selectively filtering at least one key performance indicator; selectively exporting the data table to a spreadsheet program; graphing an average absolute price deviation for each security type based on an aggregation of contributed prices; filtering the data table to limit the securities displayed in the table to meet user specified criteria; calculating and plotting a trend analysis that is selected from a group consisting of standard deviation trend, SFAS 157 deviation trend, percent deviation trend, wherein the percent deviation is an average absolute price deviation between a user's portfolio and all other contributors over a date rage specified by the user; and creating customized positions and pricing breakdowns selected from a group consisting of contributor type, region, product type, date, and security description.

Additional features and advantages of the securities' value monitor program will become apparent to those skilled in the art upon consideration of the following detailed description of the illustrated embodiment exemplifying the best mode of carrying out the securities' value monitor program as presently perceived.

### BRIEF DESCRIPTION OF DRAWINGS

The present disclosure will be described hereafter with reference to the attached drawings which are given as non-limiting examples only, in which:

FIG. 1 is a schematic view of a computer system and network of the type on which the subject matter of this disclosure can be used;

FIG. 2 is a flowchart depicting the process the securities value monitor employs;

FIG. 3 is a detail flowchart demonstrating how information is received to calculate key performance indicators in order to produce various reports; and

FIGS. 4 through 51 are screen shots of an illustrative embodiment of the security value monitor.

Corresponding reference characters indicate corresponding parts throughout the several views. The exemplification set out herein illustrates embodiments of the securities' value monitor program, and such exemplification is not to be construed as limiting the scope of the securities' value monitor program in any manner.

### DETAILED DESCRIPTION OF THE DRAWINGS

The present disclosure is directed to a securities value monitoring program system that creates a user community over the Internet to evaluate relevant security instruments by comparing the user's market value 104 data to corresponding data from other contributors anonymously to determine a fair value for the securities based on objective criteria. Market value is equal to market price multiplied by quantity.

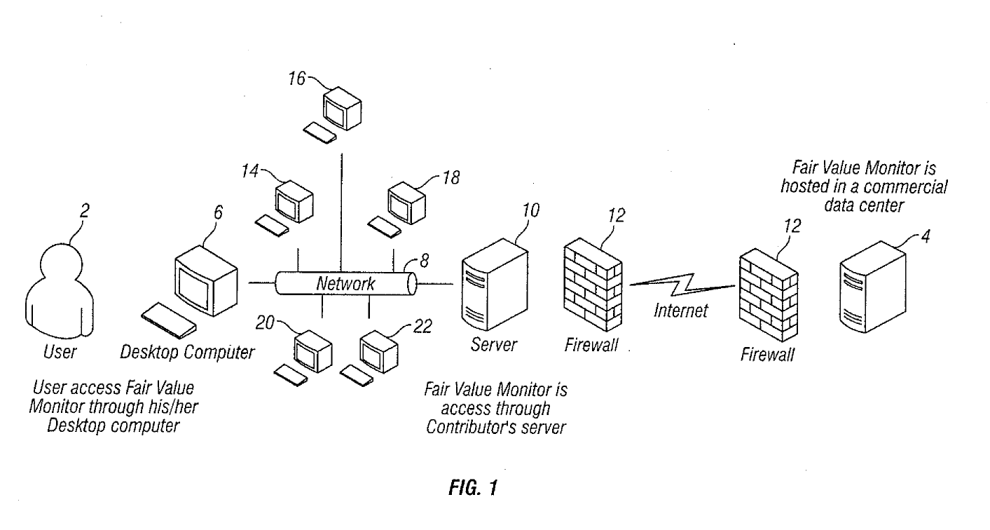

The schematic view of FIG. 1 demonstrates how data files that include securities information transfers between a user 2 and computer system 4 housing the securities value monitor system. In this illustrative embodiment, a computer 6 transfers a data file through network 8 until it reaches an Internet server 10. The data file then transfers between firewalls 12 and is received by computer 4 which includes the securities value software. This view also demonstrates how many users may anonymously contribute real securities data to a central location that processes and displays the data to provide accurate real-time valuing from real numbers. It is appreciated that other contributors 14, 16, 18, 20, and 22 can upload their own data files to contribute to the overall fair value calculation of a particular security or securities.

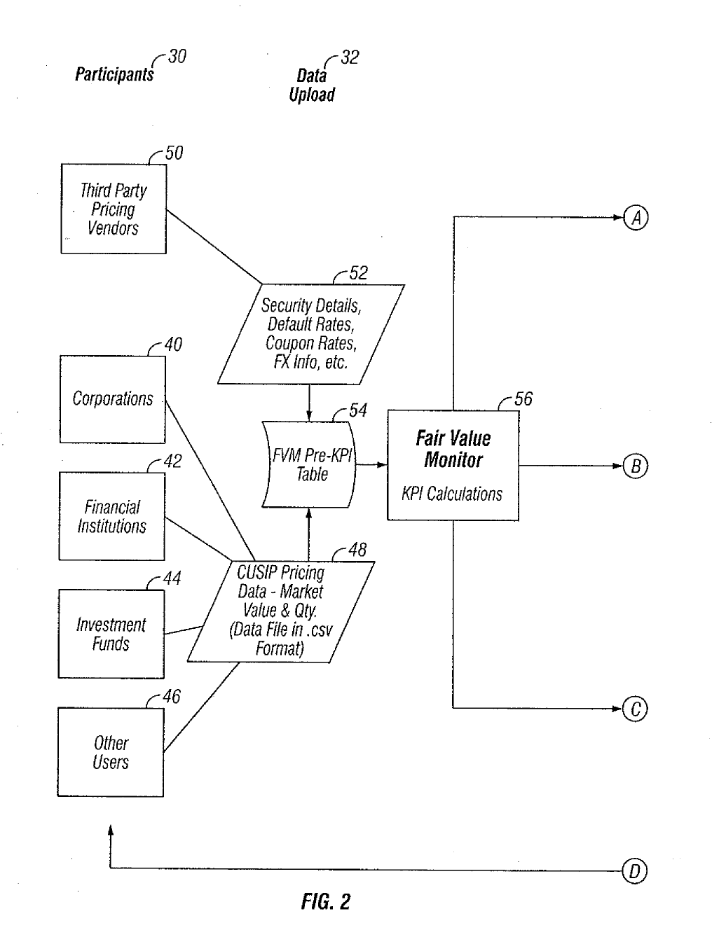

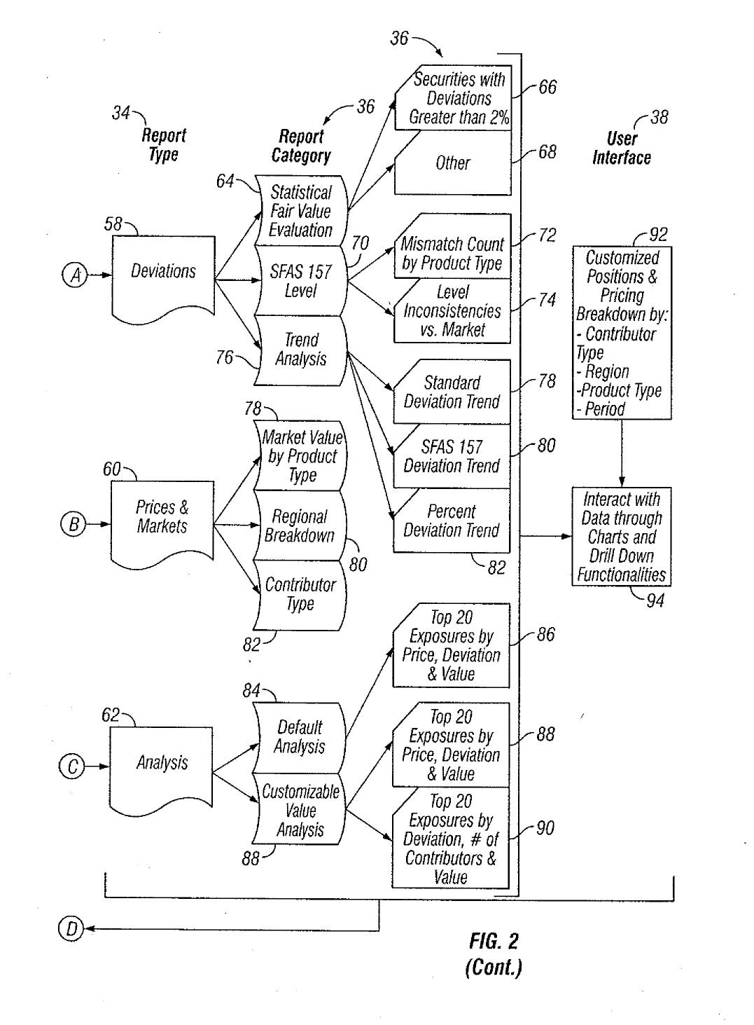

FIG. 2 is a flowchart demonstrating how the software works starting with entry by participants 30, uploading data at 32, developing reports at 34, and filtering at 36, to the user interface 38. Participants 30 are the variety of users who contribute their securities data to the monitor. For example, corporations 40, financial institutions 42, investment funds 44, and other users 46, such as individuals 46, may all contribute CUSIP pricing data at 48, such as identity of the security, market value, and quantity, an identifier for the user, unit price 110 (i.e., price of an asset as calculated by dividing total market value by units), and SFAS 157 Level 108 (i.e., classification of an assets Fair Value Hierarchy level as defined by Statement of Accounting Financial Standard 157) disclosure. In an illustrative embodiment, the data file can be in a .csv format. In addition, third party pricing vendors at 50 may contribute security details, default rates, coupon rates, FX information, etc. at 52. Each of these contributors may upload their securites' information to collectively assess their value. With the data files uploaded, a data table is created at 54. To ensure smooth uploading, as well as keeping the unit prices relevant, a verification on the data file is performed. The verification looks at the types of characters located in each field making sure they are at least alpha numeric in alpha numeric fields and numbers in numeric fields. Null or zero values are also rejected. Substantively, pricing is illustratively limited to a predetermined date range so stale prices do not matriculate into the valuations. Lastly, outlier data is reviewed. Outlier data is data that may or may not be accurate so it needs to be reviewed. For example, duplicate data for a particular security over multiple days could indicate a duplicate entry. Drastic price change over a short time period may indicate an exceptional circumstance that could skew data but shouldn't. This data is not rejected but is made available for the users review to confirm acceptable before continuing. If any data is rejected, the data file can be repopulated with acceptable data and then uploaded again.

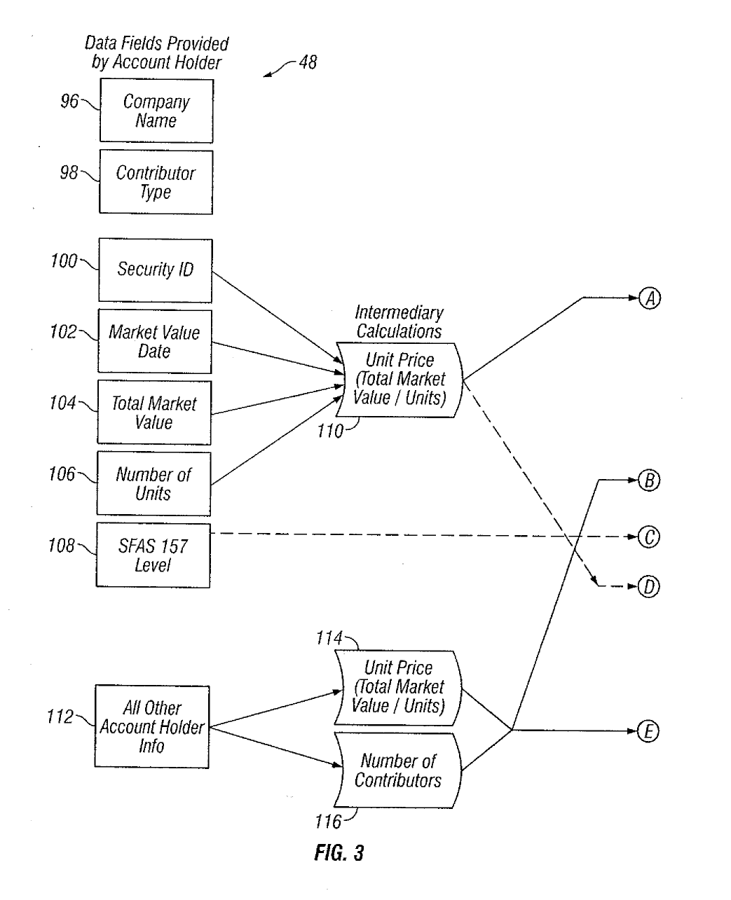

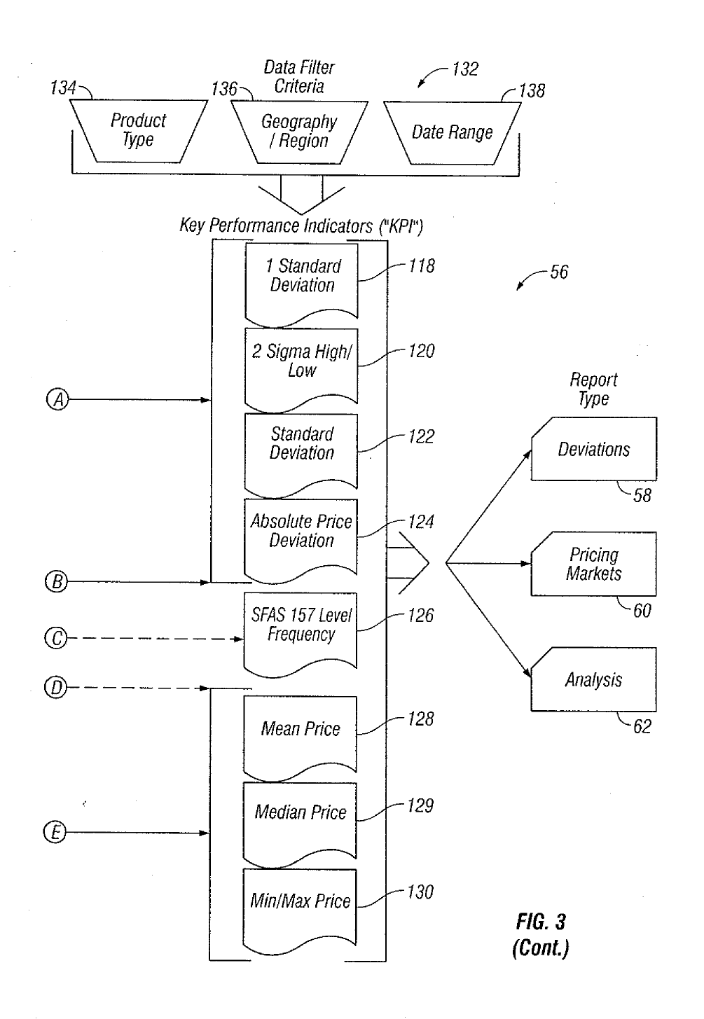

Once the acceptable data is uploaded from the user's network, it is merged with corresponding data provided by the other participants 30 relevant to the security or securities. With this data, key performance indicators may be calculated at 56 to immediately produce value information with the combined data. Standard deviation 122 (i.e., calculated as price variance divided by 1 standard deviation; the number of standard deviations account holder price is from the Mean price), 1 standard deviation (i.e., measure of the dispersion of unit prices provided by all contributors), 2 sigma high/low, absolute price deviation 124 (i.e., percentage deviation of “my market price” from the weighted average mean market price; calculated as price variance (my market price−weighted average mean price] divided by weighted average mean market price), SFAS 157 Level frequency 126 (i.e., count of contributors utilizing SFAS 157 Level other than SFAS 157 Level utilized by account holder divided by number of contributors), mean, median, minimum or maximum prices are all calculated from the merged data. (See FIG. 3.) These calculations are performed using software such as Altosoft's Insight software.

Reports 34 can take the form of deviations at 58, prices and markets at 60, and analysis at 62. These reports allow the user to organize and consider the data in a way that makes the most sense to him or her. Each report views the data from a different perspective. For example, deviations report 58 views the statistical fair value evaluation from the data at 64. This can be filtered even further to view securities with deviations greater than 2 percent and others at 66 and 68, respectively. Mismatch accounts by product type at 72 and SFAS 157 Level inconsistencies versus the market at 74 may also be examined. The trend analysis at 76 looks at standard deviation SPAS 157 deviation and percent deviation trends at 78, 80, and 82, respectively.

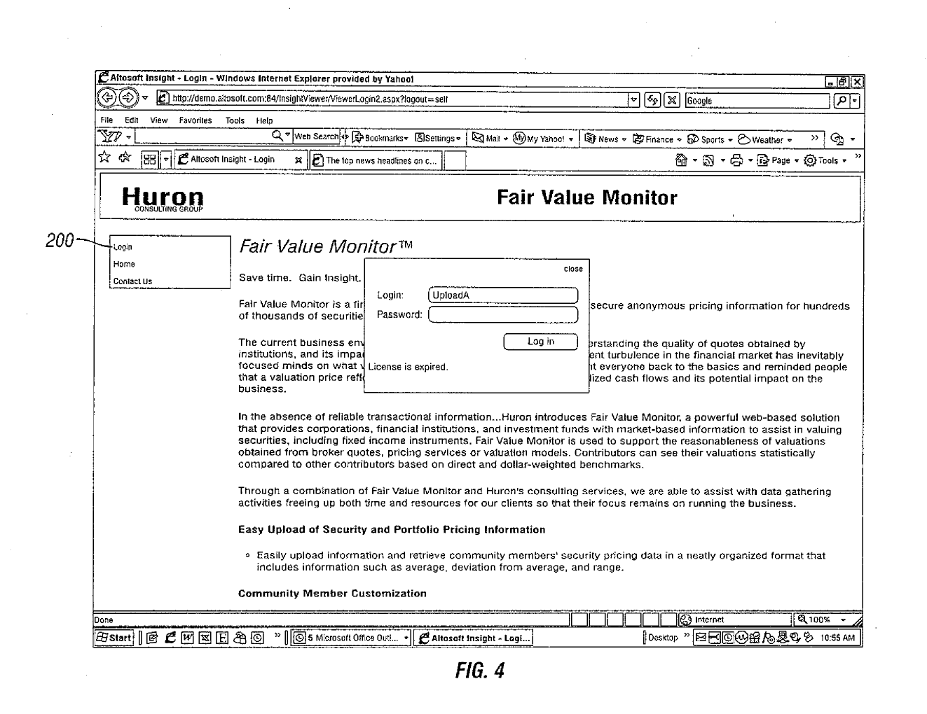

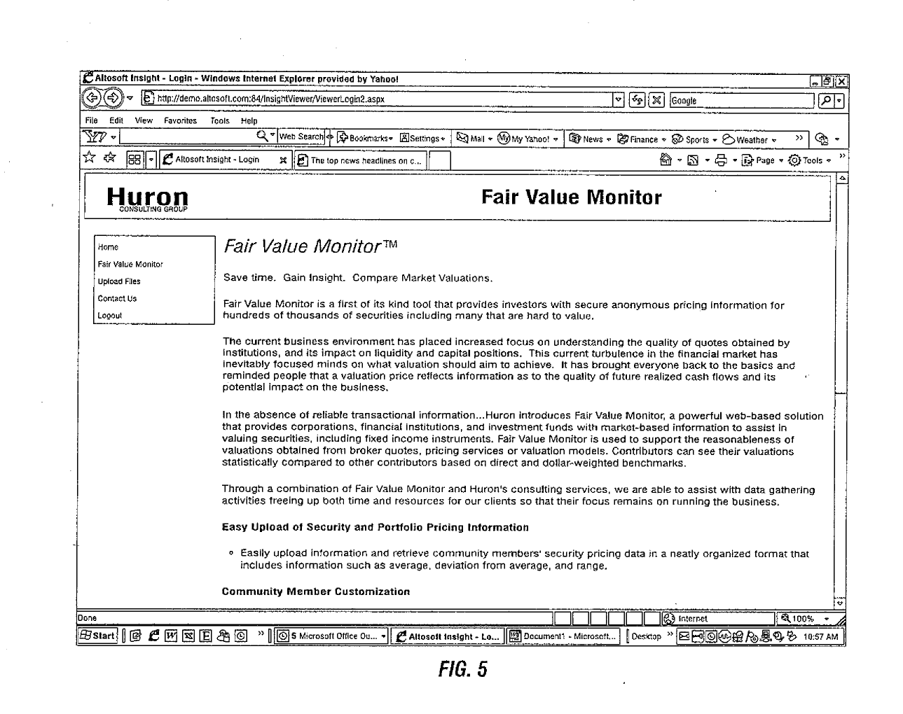

As shown in FIG. 4, a user can gain access to the security value monitor website or program. The user can activate a login button at 200 to enter a login and password at 202 to further access the program. As shown in FIG. 5, once logged in an option appears to view data previously contributed to the security value monitor functionality.

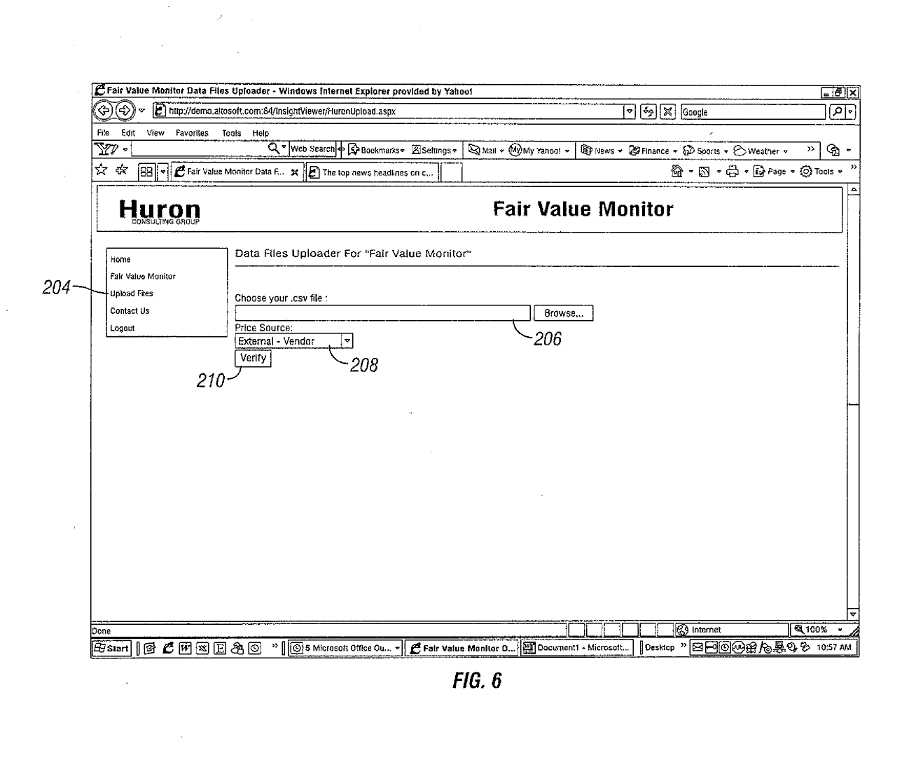

FIG. 6 shows that by selecting upload files at 204, the user has the option of either entering a file name or browsing at 206 to locate the data file previously prepared. In addition to choosing the upload file, a price source at 208 is chosen. Price sources may be obtained from Bloomberg, Reuters, Interactive Data or other broker, dealers or automated pricing vendors. With the data file entered and price source chosen, a verify button 210 can be activated to proceed to the next step.

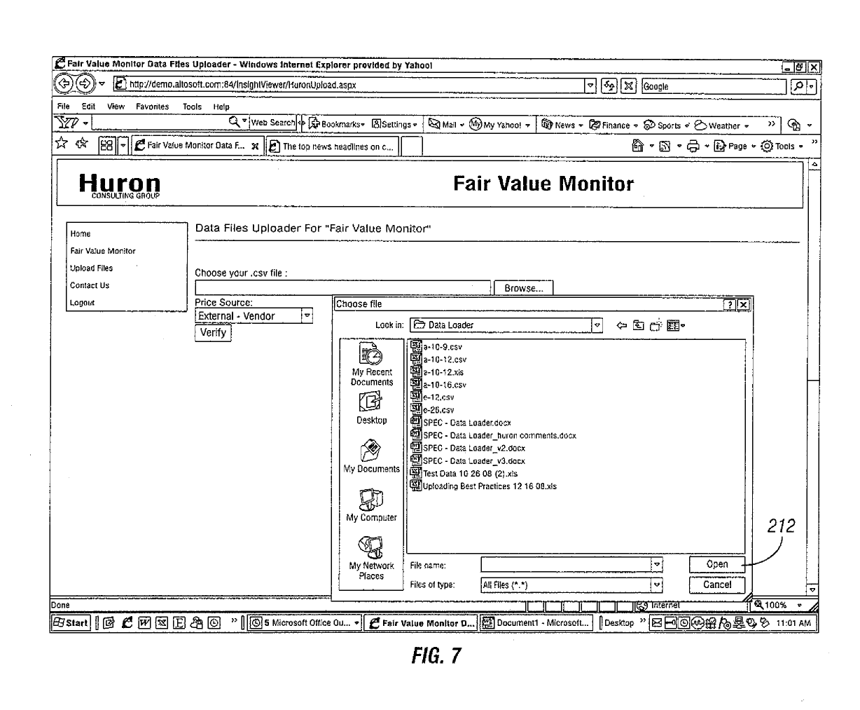

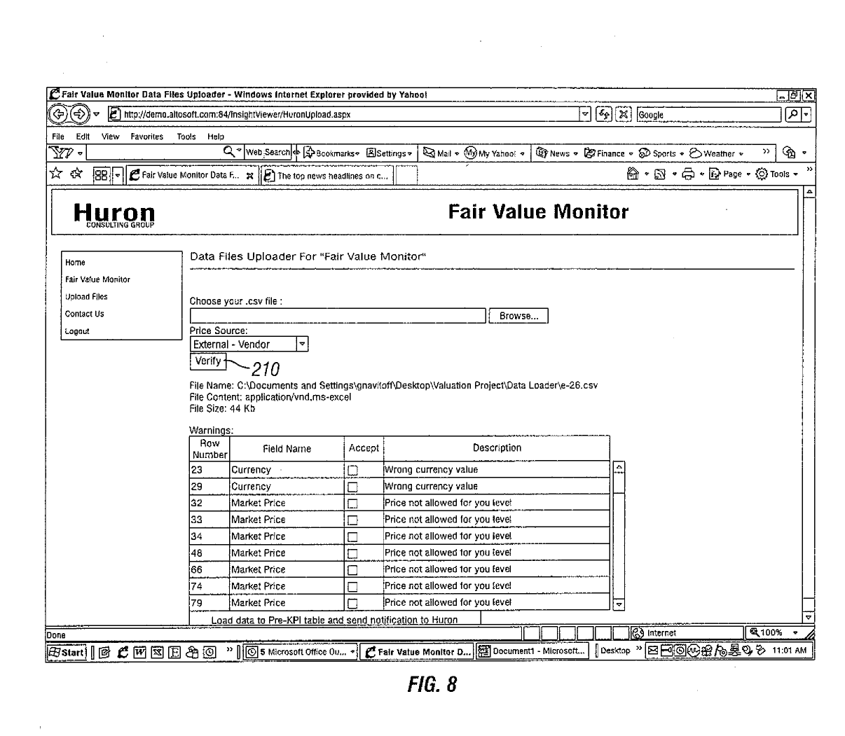

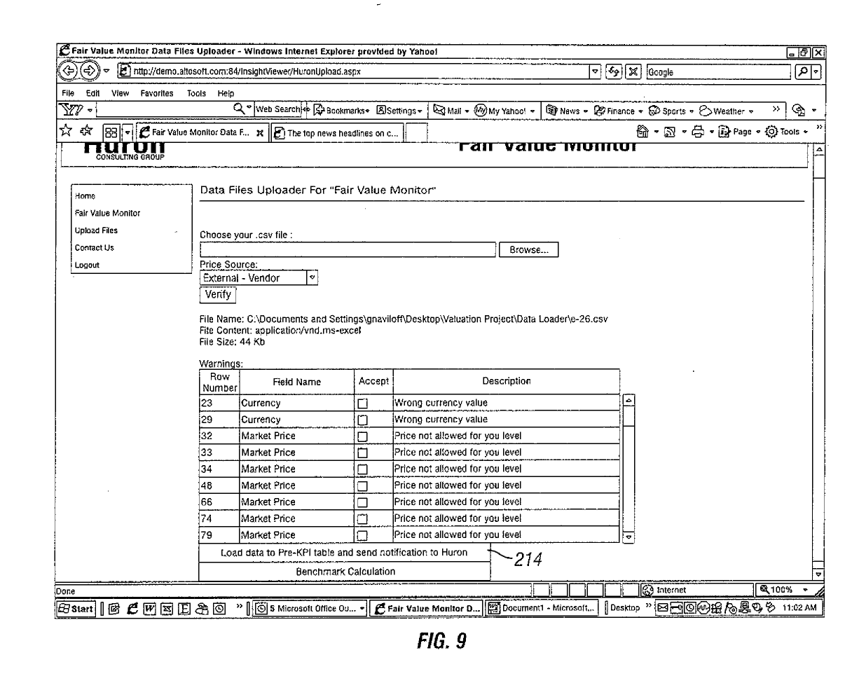

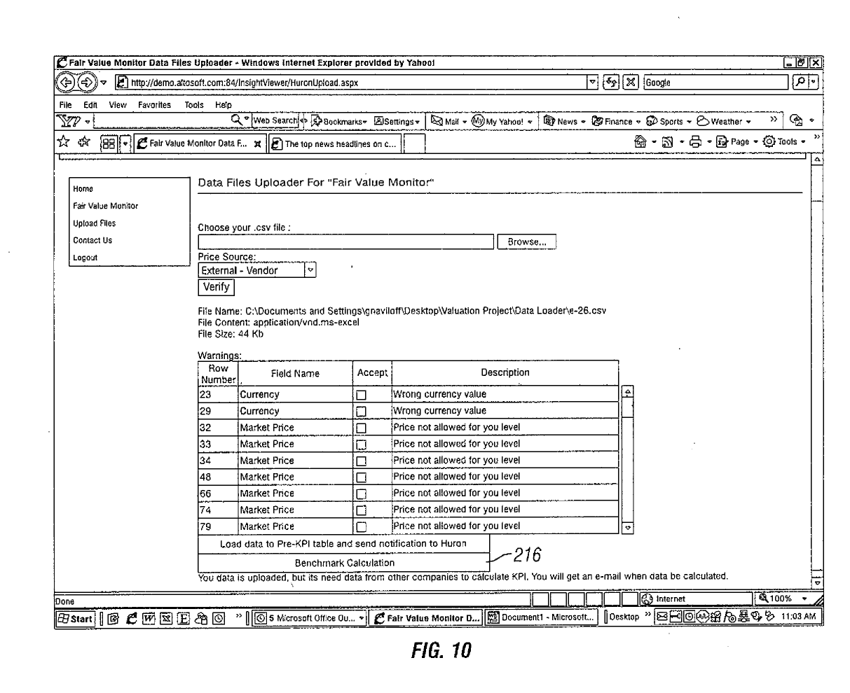

In an illustrative embodiment shown in FIG. 7, the user then navigates through their directory to select the appropriate pricing file. Once selected, the open button 212 is activated. With the upload file identified, FIG. 8 shows the data file being verified before proceeding to merging this data with other data. Upon activating the “verify” button 210, the data file is illustratively copied to the security value monitor data base to perform a plurality of data validation checks. The validation checks illustratively comprise ensuring alpha characters only appear in alpha fields, alpha numeric characters in alpha numeric fields, and numbers in numeric fields; blocking unreasonable date ranges to limit user pricing contributions to a predefined period of time (such as a 90 day rolling window for each pricing date) and pricing outside of the preselected date is rejected; rejecting zero and no values; and reviewing outlier which compares data currently being loaded by the user with data previously loaded by the user to identify any unusual changes in the market value columns. Rejected data is identified to the user. One illustrative embodiment may accept rejected data “as is,” or in another embodiment, be required to prepare a new data file. As shown in FIG. 9, once the verification process is complete, the user can select a “load data” button 214 to continue uploading the data. As shown in FIG. 10, once loading the data file is complete, the user selects a “bench mark calculation” button 216 to merge the data file with data provided by other contributors. In an illustrative embodiment, the user will be notified when the upload process is complete. Selecting the fair value monitor button 218 can be activated from the menu to navigate to the analytical tools.

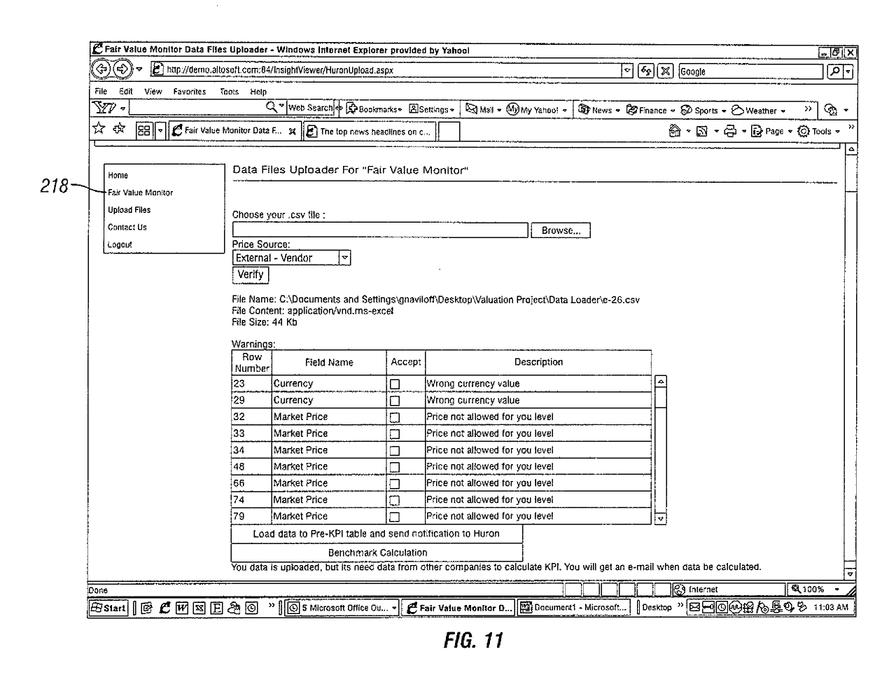

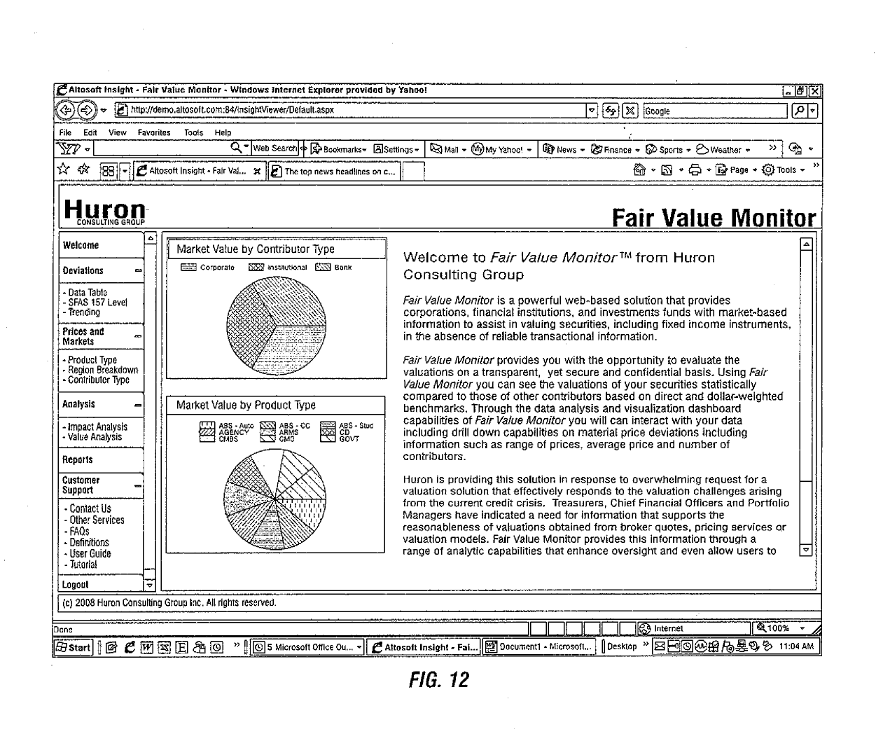

In an illustrative embodiment, a landing page of the security value monitor, as shown in FIG. 12, provides the user an overview of the total market value of the assets contributed by all security value monitor contributors by both contributor and product types.

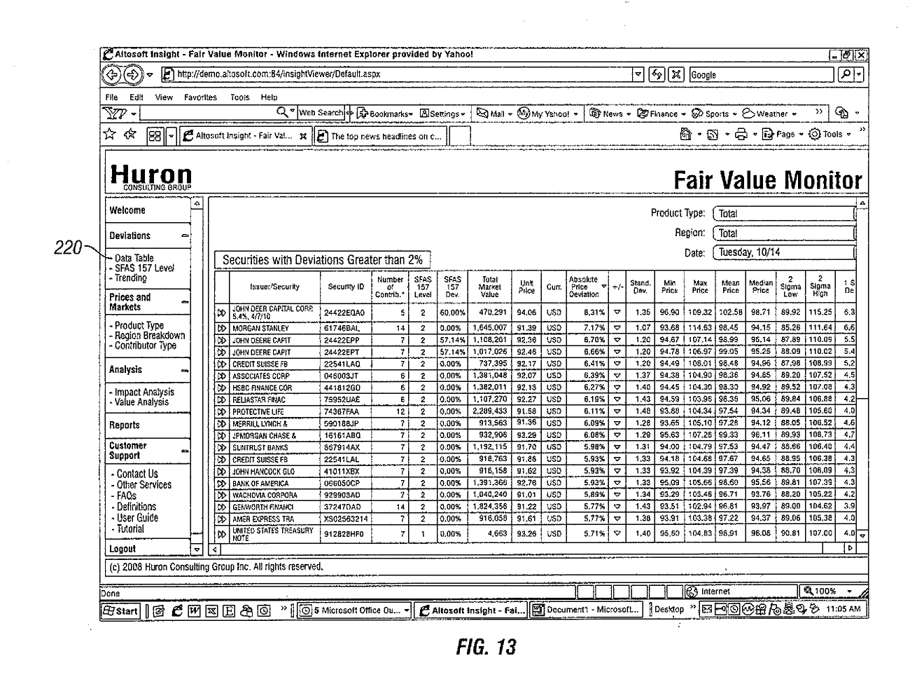

Selecting a “data table” button 220, as shown in FIG. 13, provides the user with a listing of securities contributed to the security value monitor. In an illustrative embodiment, the securities listed may be limited to only those securities contributed by the user. It is appreciated that the table can be further filtered to include securities where the price provided by the user is more than 2% greater than the weighted average mean of the prices provided by other contributors.

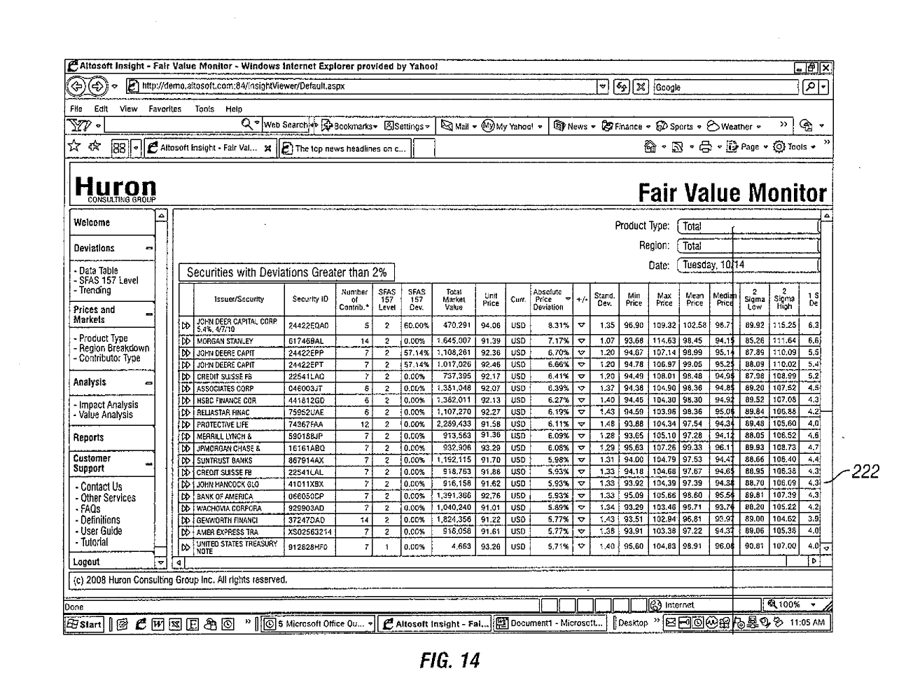

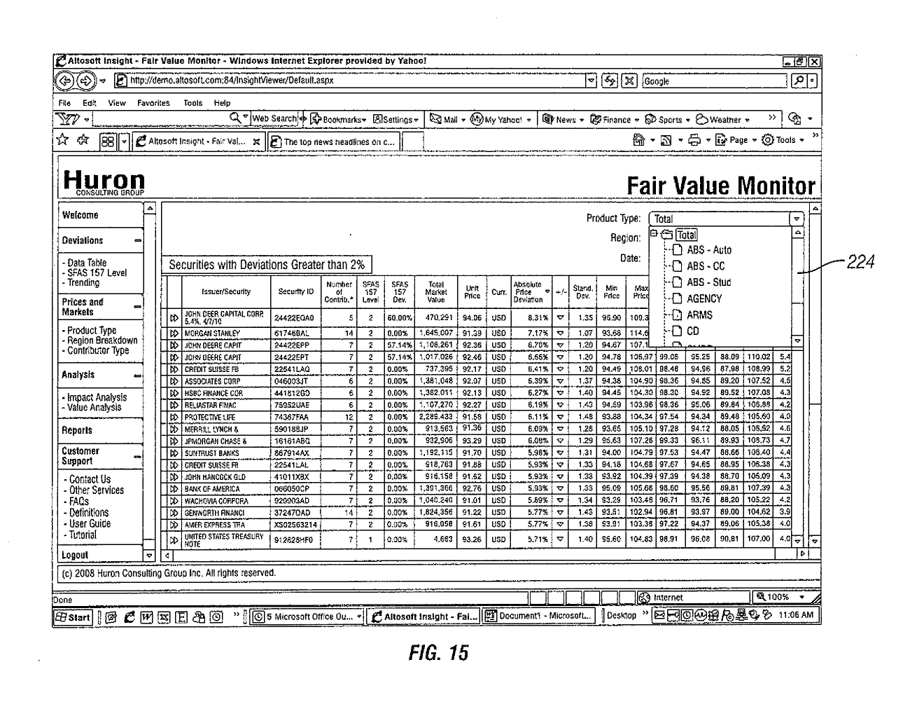

The data table 222 shown in FIG. 14 includes columns for issue/security, security ID 100 (i.e., a unique identifier assigned to the security, illustratively representing a 12 digit ISIN or 9 digit CUSIP number), number of contributors 116 (i.e., total number of contributors who have provided pricing information), SFAS 157 Level, SFAS 157 deviation, total market value, unit price, currency, absolute price deviation, +/−, standard deviation, minimum price, maximum price, mean price, median price 129 (i.e., “middle” unit price provided by contributors, excluding account holder's pricing info), 2 sigma low 120 (i.e., the low unit price is calculated as 2 standard deviations distance lower than the mean unit price; under normal price distribution theory no more than 2.1% of contributors would be expected to price an asset's value below this threshold), and 2 sigma high 120 (i.e., the high unit price calculated as 2 standard deviations distance higher than the mean unit price; under normal price distribution theory no more than 2.1% of contributors would be expected to price an asset's value above this threshold). In an illustrative embodiment the user securities are matched against security pricing information provided by other contributors. The number of other contributors providing pricing information for each security is noted in the number of contributors' column. As part of the information uploaded from the user data file, the SFAS 157 disclosure level is illustratively included in table 222. The security value monitor may calculate and provide the user with columns showing the percentage of contributors who have SFAS 157 disclosure levels other than that of the user. The security value monitor database also calculates and provides the user with the key performance indicator calculations for each matched security, as previously discussed. Four of the calculations provide pricing distribution information compared to normal distribution and five calculations provide price ranges and averages. Each price calculation provides the user with an additional piece of quantitative pricing information to help evaluate the pricing positions.

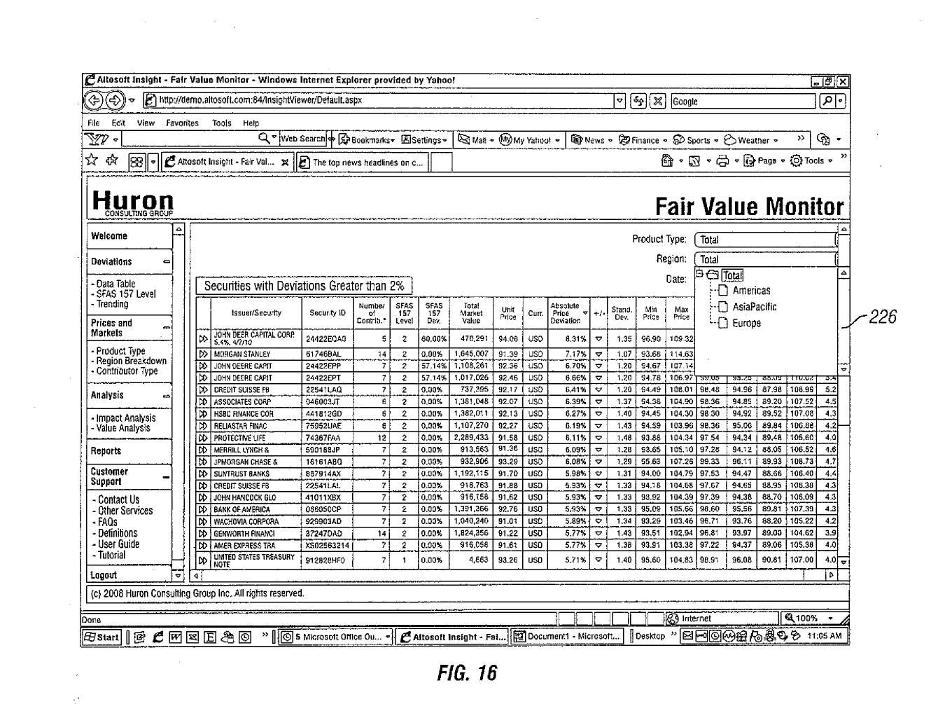

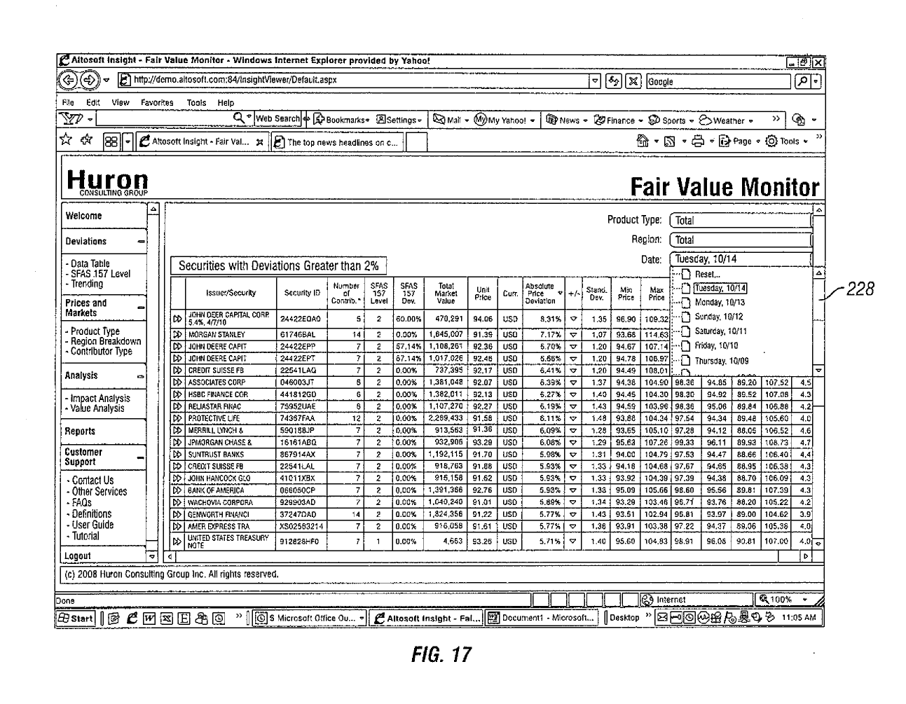

The securities' value monitor has additional functionalities including filtering data. In one illustrative embodiment, a drop down menu 224, next to the “product type” field (while still on the “data table” screen), provides the user with the ability to add a single filter to limit the data displayed to the specific product type selected. Product type examples include Assets Backed-Securities including related sub-classifications such as Credit Cards, Automobiles, etc, Mortgage Backed Securities including related sub-classifications such as RMBS, CMBS, etc., government and government agency bonds, municipal bonds, foreign government bonds, private equity instruments, etc. Another filter-region, shown at 226 in FIG. 16, provides the user with the ability to limit data displayed to specific geographic regions, such as the Americas, Asia Pacific, or Europe. Selecting the “date” drop menu 228 allows the user to limit results to only those dates selected by the user. These dates are historical and limited to dates and securities for which each user has provided pricing information.

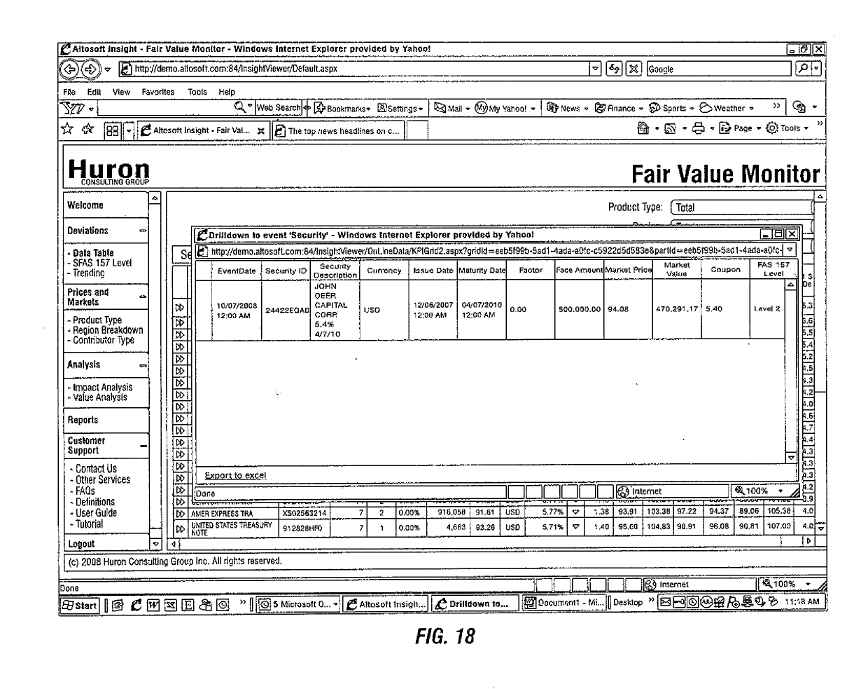

The user also has the ability to view pertinent information related to each security and a listing of prices provided by other contributors, as shown in FIG. 18. Illustratively, the price list can be filtered to only include prices from contributors who have opted to disclose this information, as contributors have the option of keeping their securities pricing information completely anonymous.

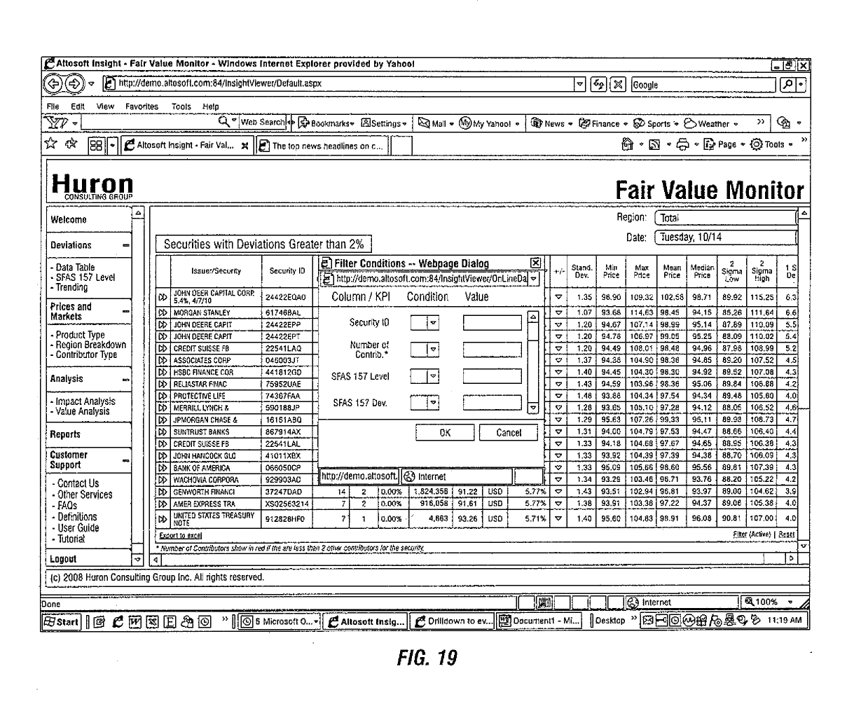

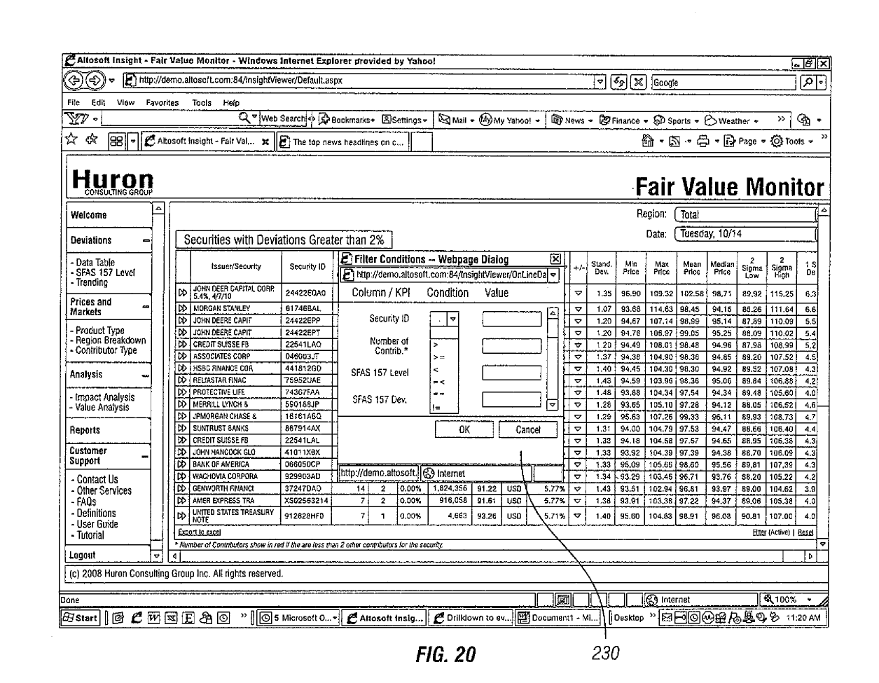

More filtering is available to provide the user with the ability to create multiple filters based upon multiple fields, as shown in FIG. 19. This limits the securities displayed to only those meeting multiple user specified criteria. Such filters, as shown in FIG. 20, include security ID, number of contributors, SFAS 157 Level, and SFAS 157 deviation. The system is configured to employ other filters as desired. There are conditions, such as greater than or equal to, less than or equal to, and value, as indicated at 230. This value dialog box allows the user to enter a particular number for the particular column.

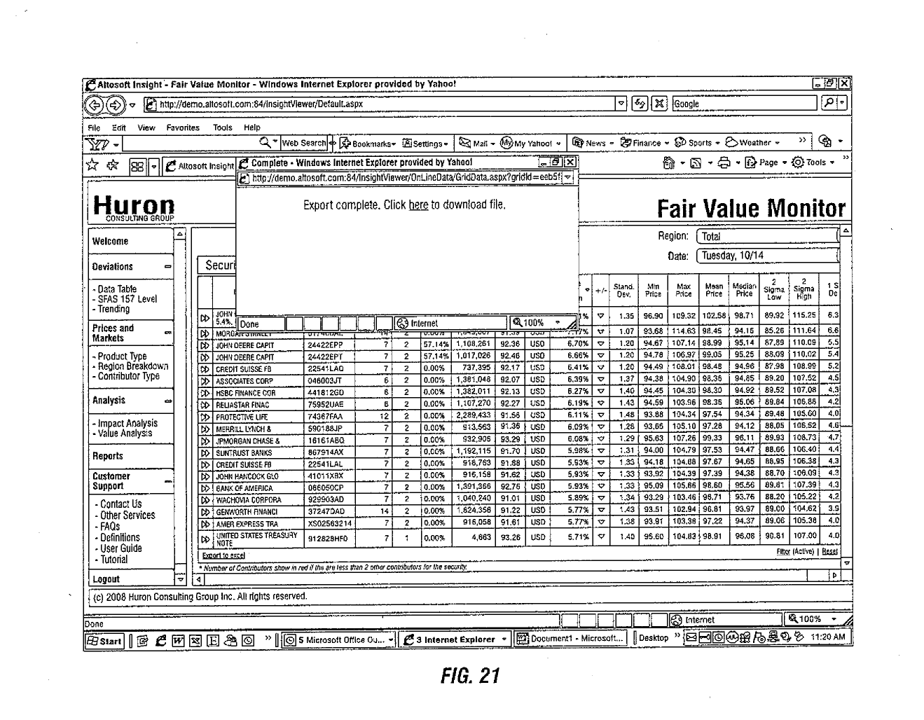

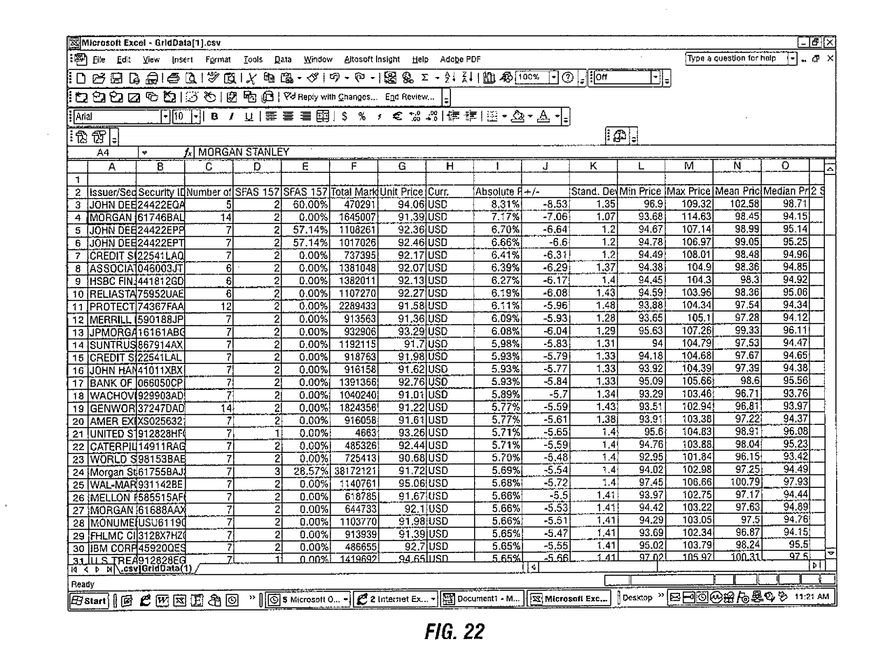

The security value monitor has the illustrative ability to export the data table into a spread sheet, such as Microsoft Excel, as shown in FIG. 21. Once in a spread sheet, as shown in FIG. 22, the data can be manipulated as the user desires.

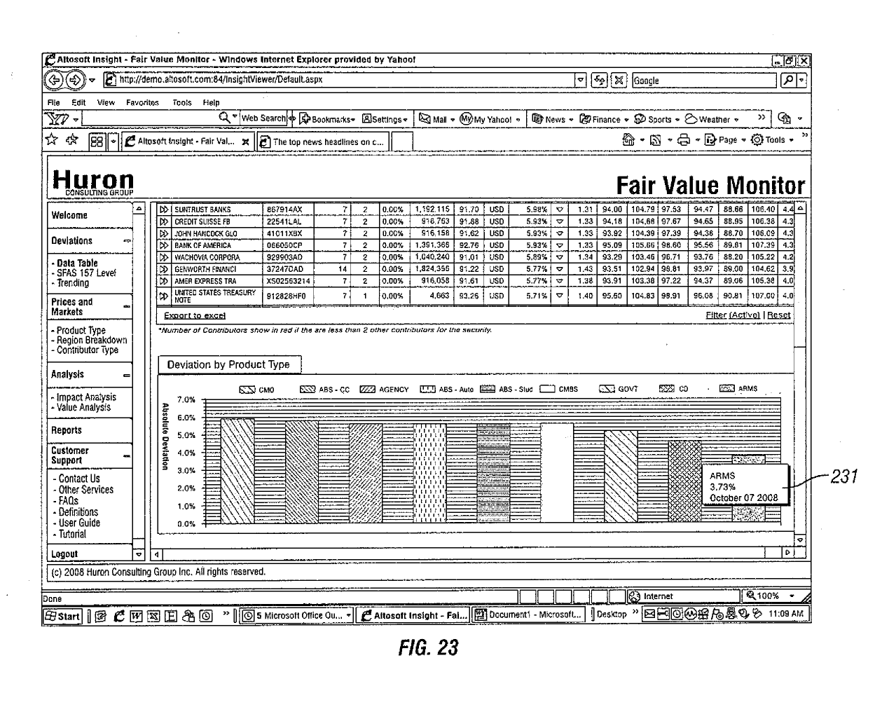

The user graphs the average absolute price deviation for each security product type, as shown in FIG. 23. This graph may be aggregated based upon pricing provided by all contributors. The data included in the graph can also be filtered by the user by employing the filters previously discussed. In an illustrative embodiment, the user can activate a pop-up window 231 by scrolling across any of the columns of the graph. Pop-up window 231 illustratively displays the product type, absolute price deviation, and pricing date for the column selected.

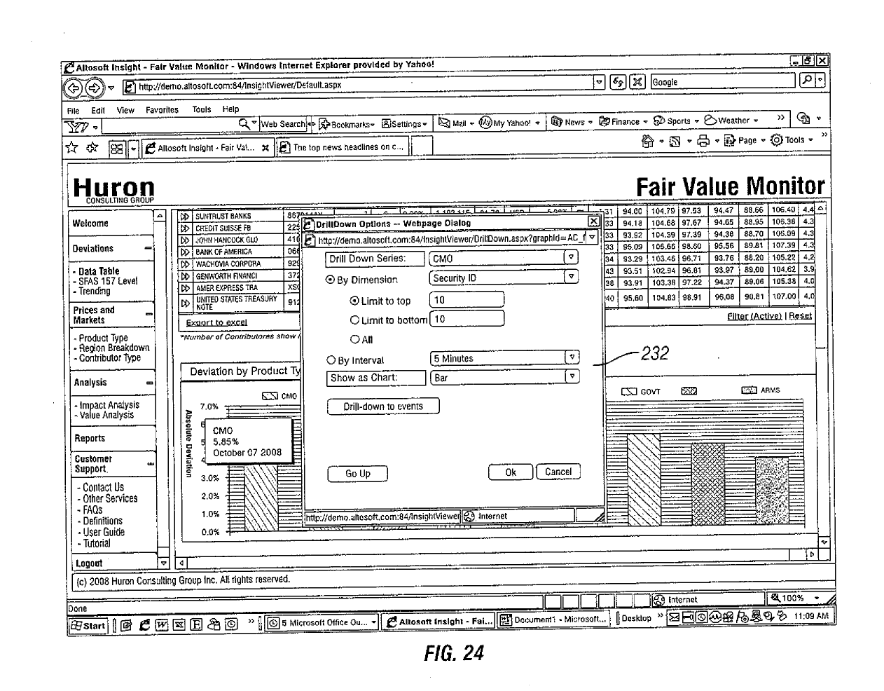

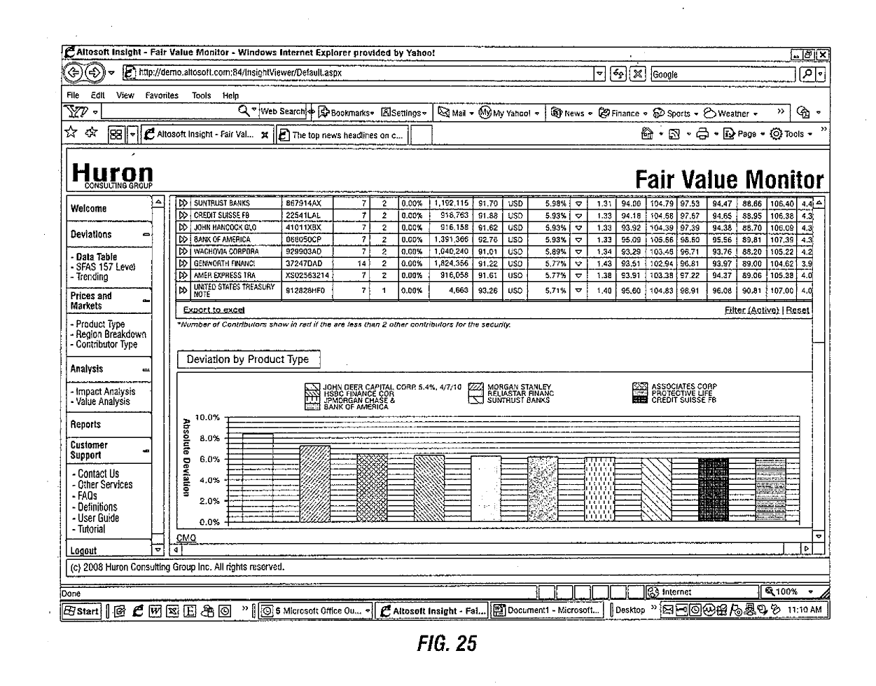

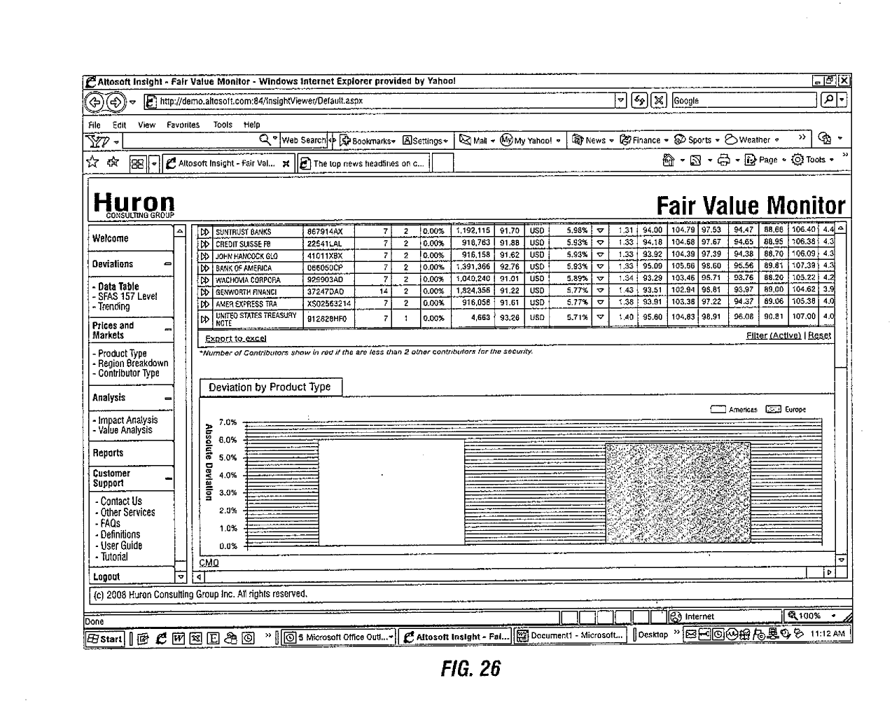

In a further illustrative embodiment, by clicking on any of the columns on the graph the user can activate a “drill down” tool 232, as shown in FIG. 24. This tool guides the user through the process of specifying graph dimensions for purposes of displaying underlying supporting data. In the illustration shown, the user may select the CMO product type, and the 10 CMO security IDs with the largest absolute deviations. The resulting graph is shown in FIG. 25. The graph shown in FIG. 26 displays the user's request to view the average absolute deviations for CMO security IDs by region.

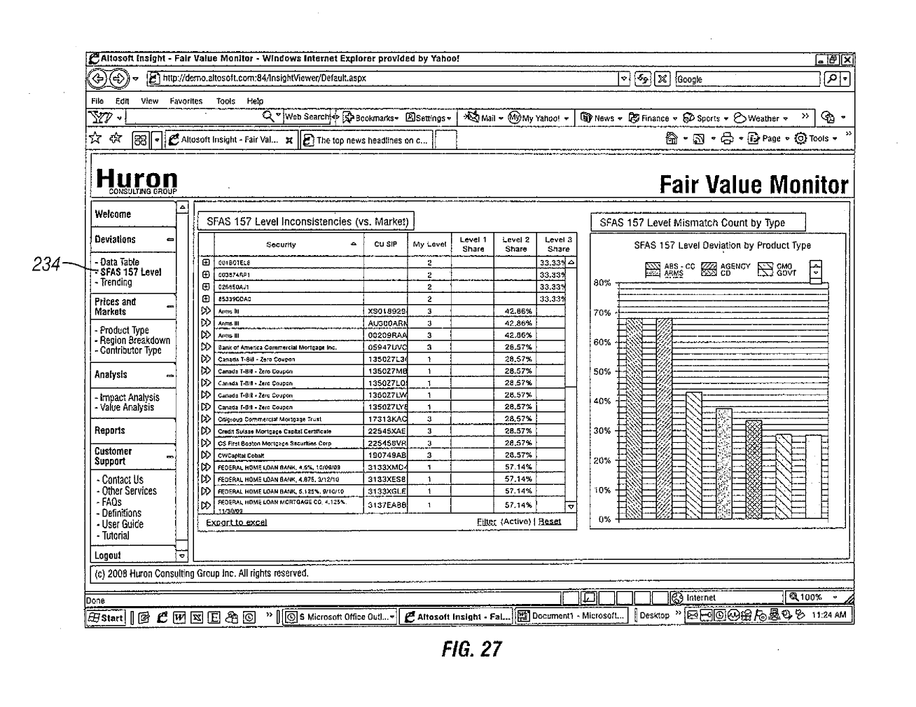

As shown in FIG. 27, the user may also select a SFAS 157 at 234 to navigate the user to a screen displaying a data table and graph containing securities for which contributors, other than the user, utilized a SFAS 157 disclosure level different than the level used by the user. The table provides columns titled “Level 1 Share,” “Level 2 Share,” and “Level 3 Share” reflecting the percentage of contributors that utilized each SFAS 157 Level disclosure. In addition, the graph can plot the average percentage of contributors by product type category that did not use the same SFAS 157 Level disclosed by the user.

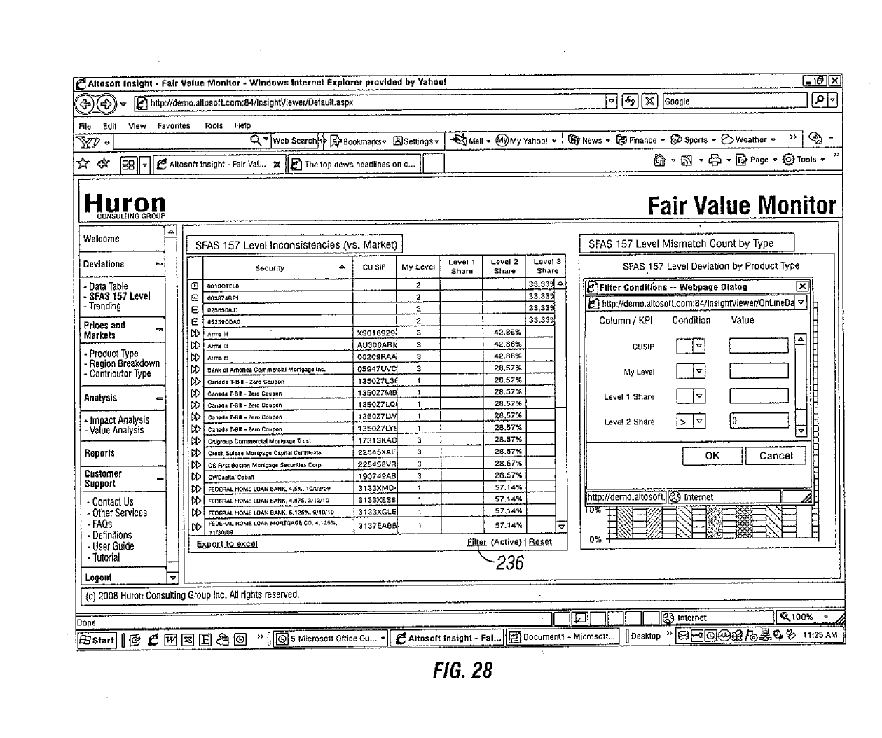

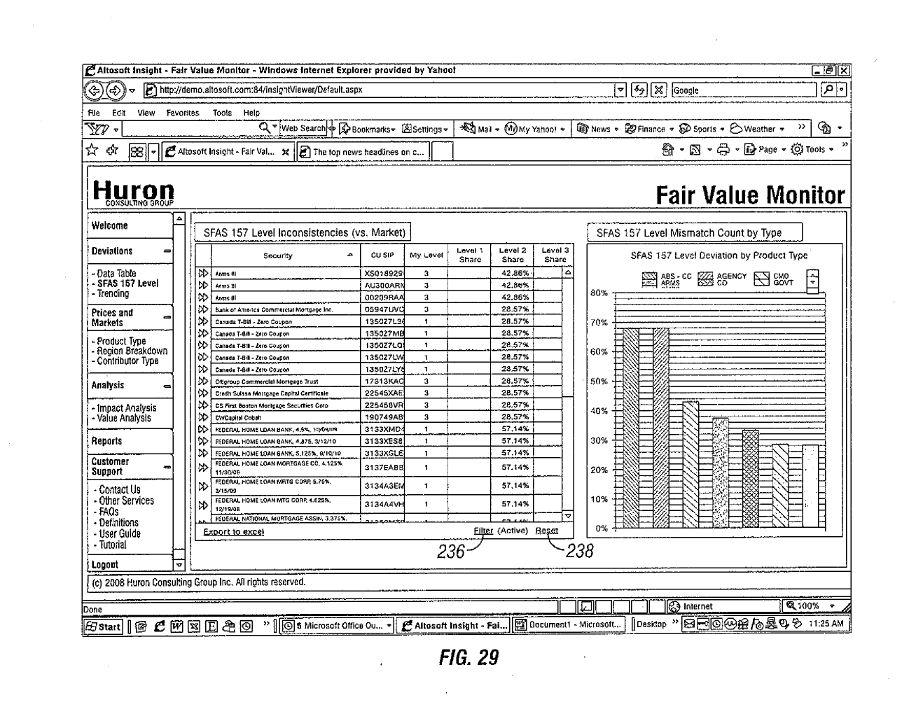

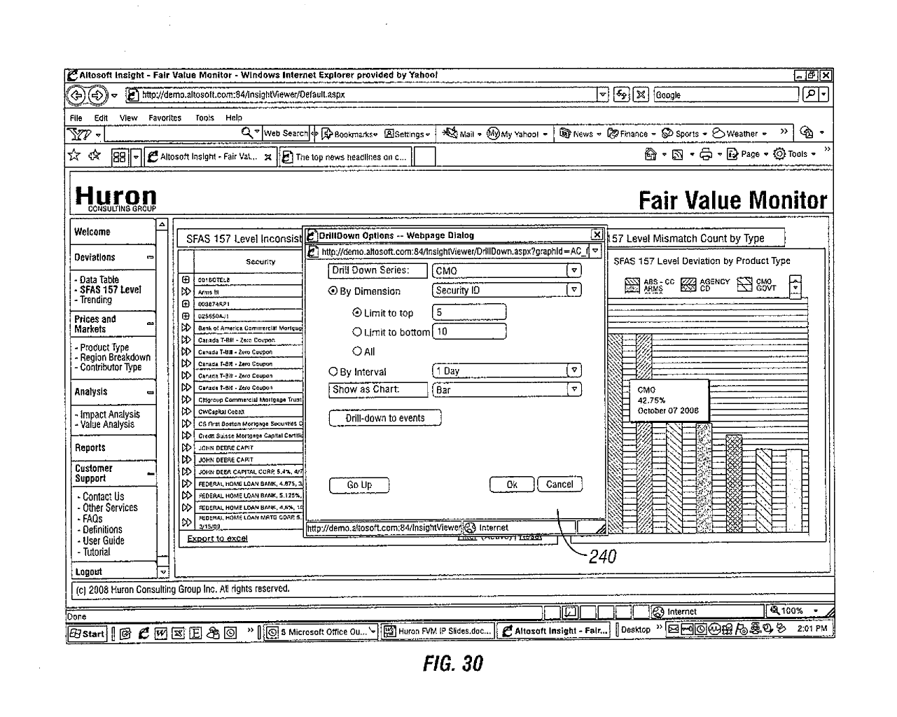

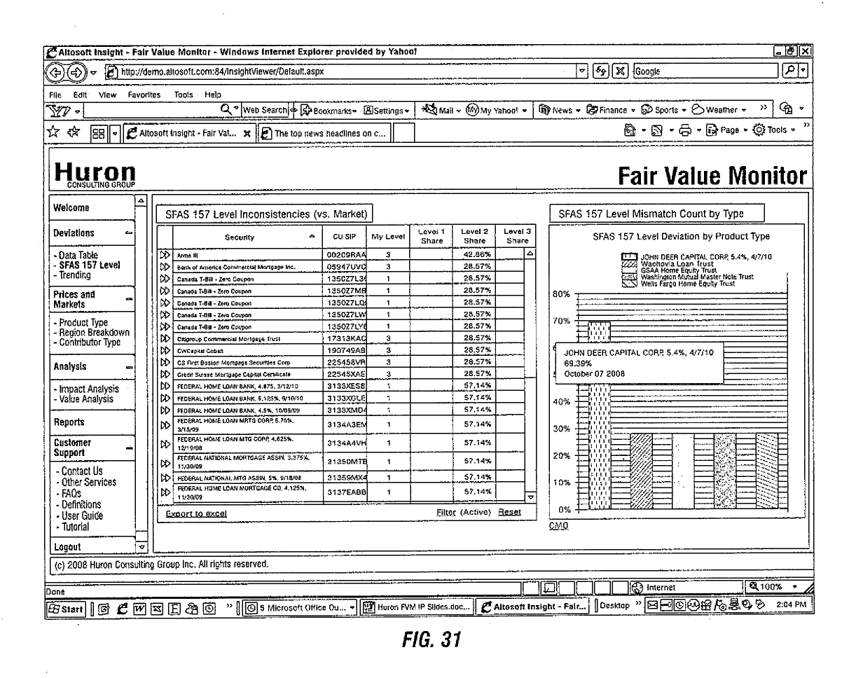

In an illustrative embodiment, shown in FIG. 28, activating a filter link 236 on the SFAS 157 Level screen provides the user with a filter tool. This filter tool has the ability to create multiple filters based upon multiple fields (such as the key performance indicators previously discussed). This focuses the securities displayed in the table to only those meeting multiple user specified criteria. Illustratively, as shown in FIG. 29, the depicted results were displayed after the user applied the filter “level 2 share >0%.” There is also illustratively a reset button 238 that can remove the filter as desired. Lastly, clicking on one of the graph bars creates drill down options 240 shown in FIG. 30 and similar to that previously discussed. As shown in FIG. 31, the resulting graph displays the five CMO security IDs with the highest frequency of SPAS 157 Level mismatch per the user's request.

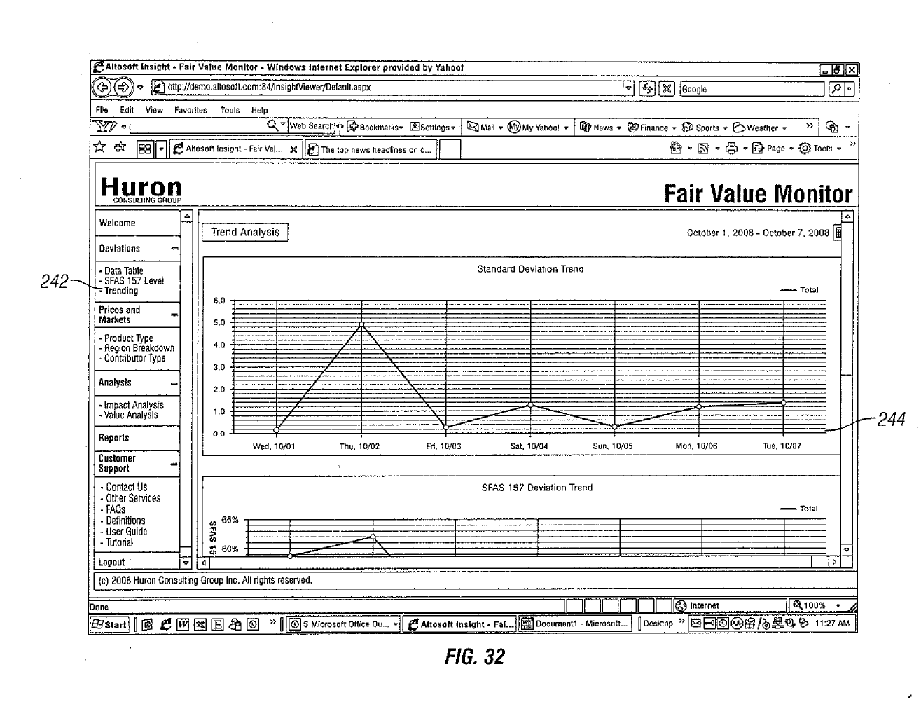

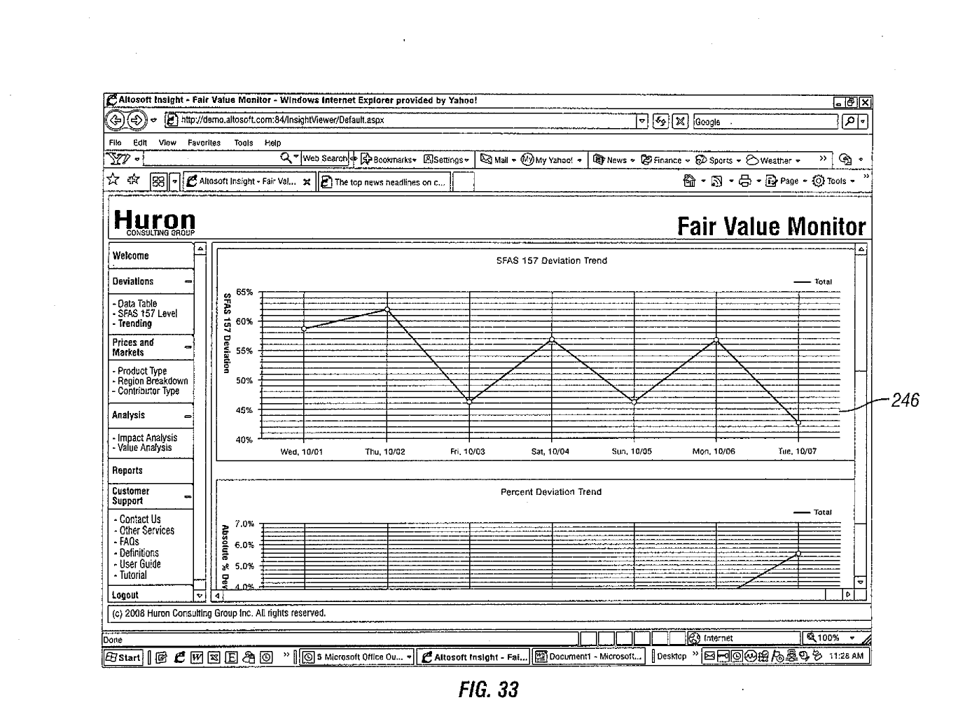

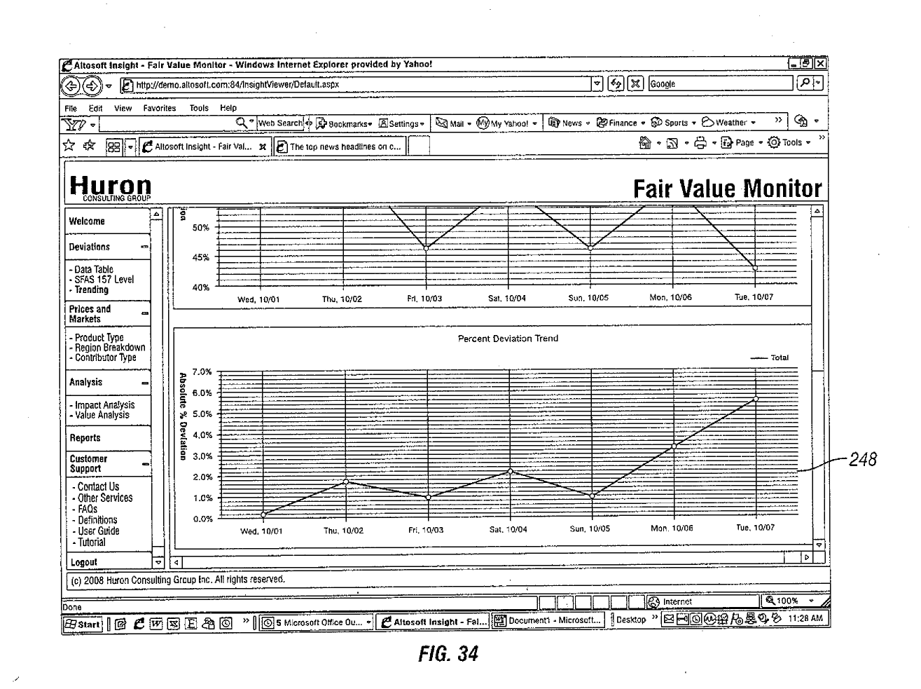

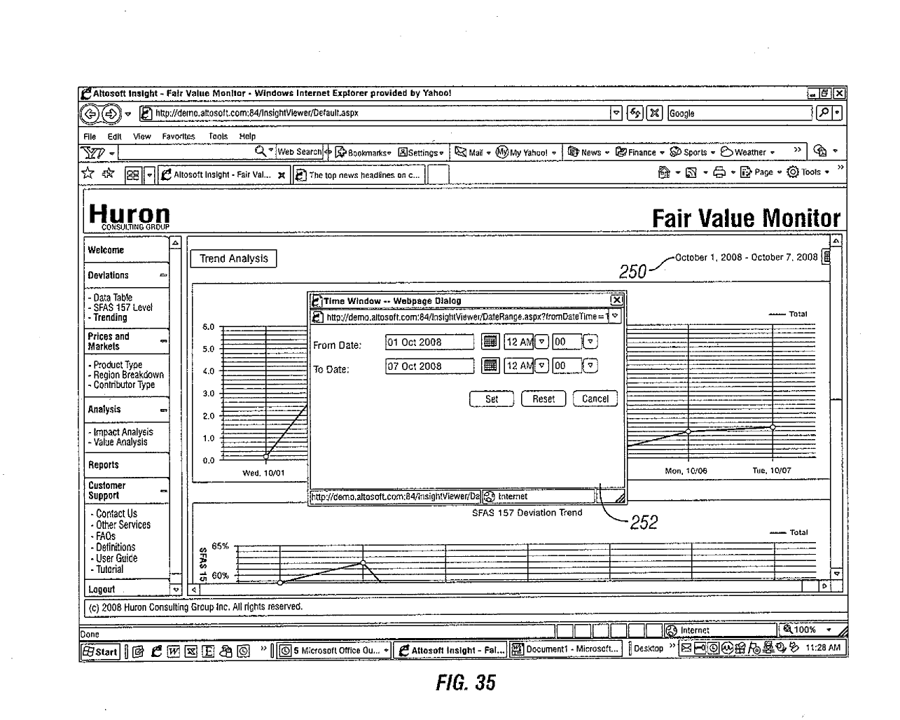

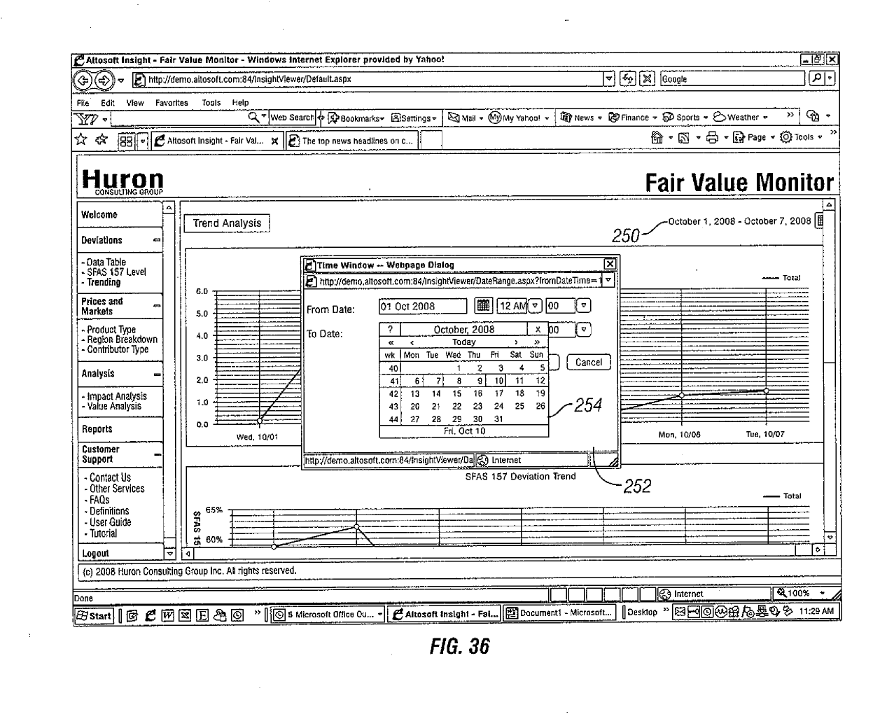

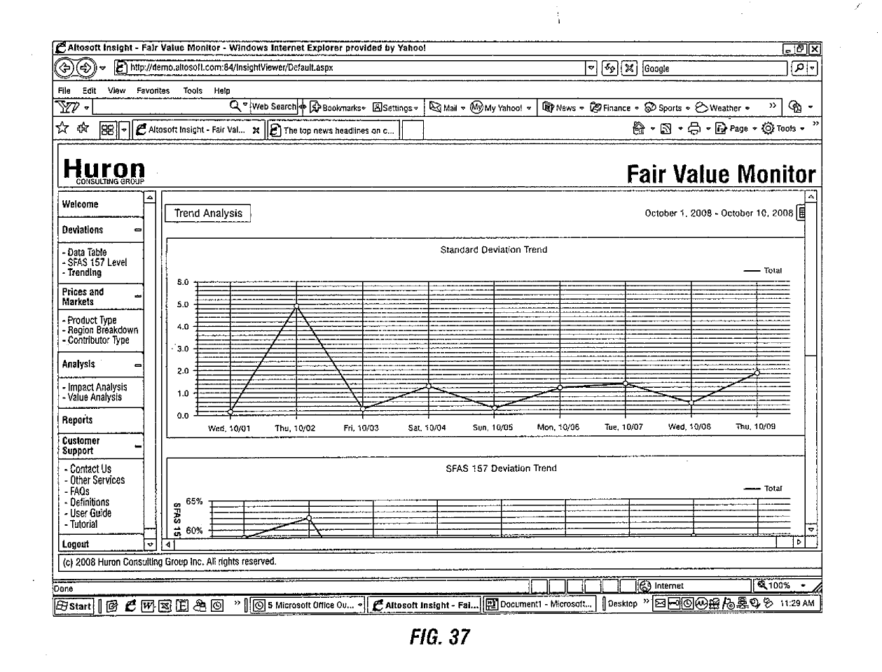

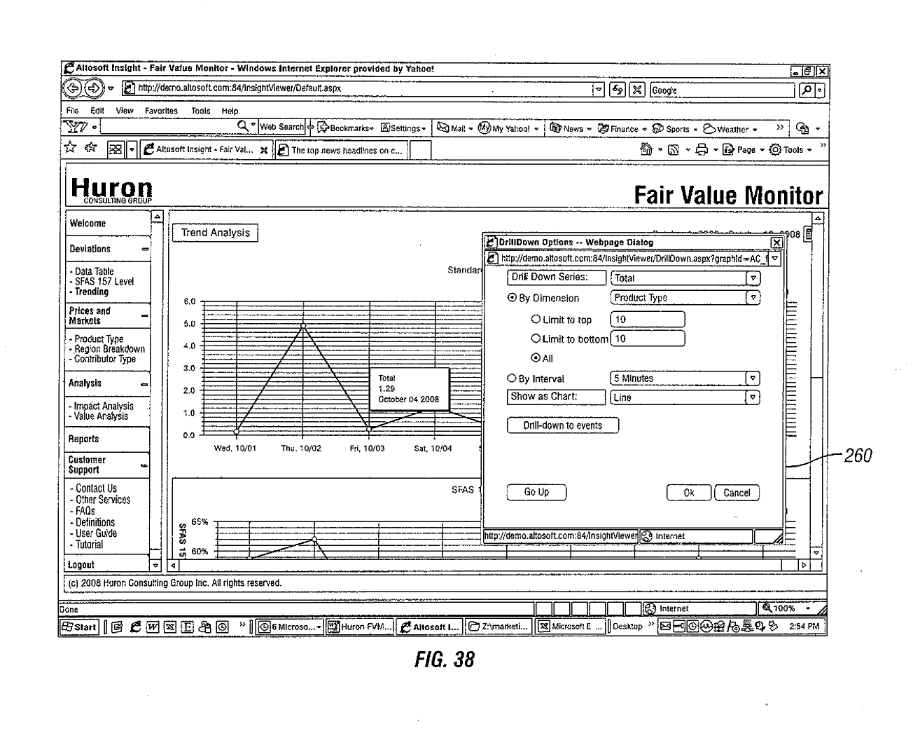

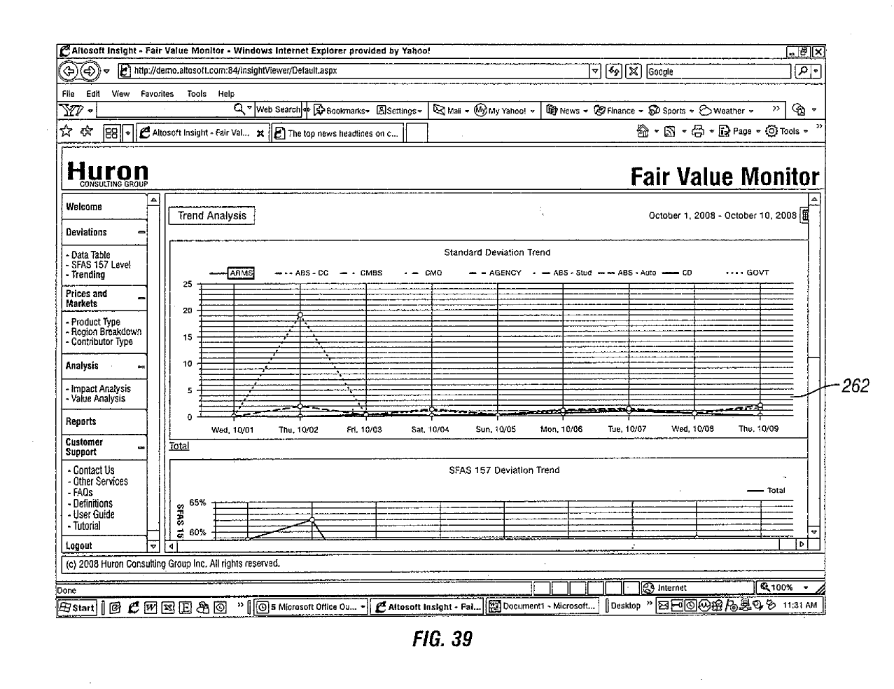

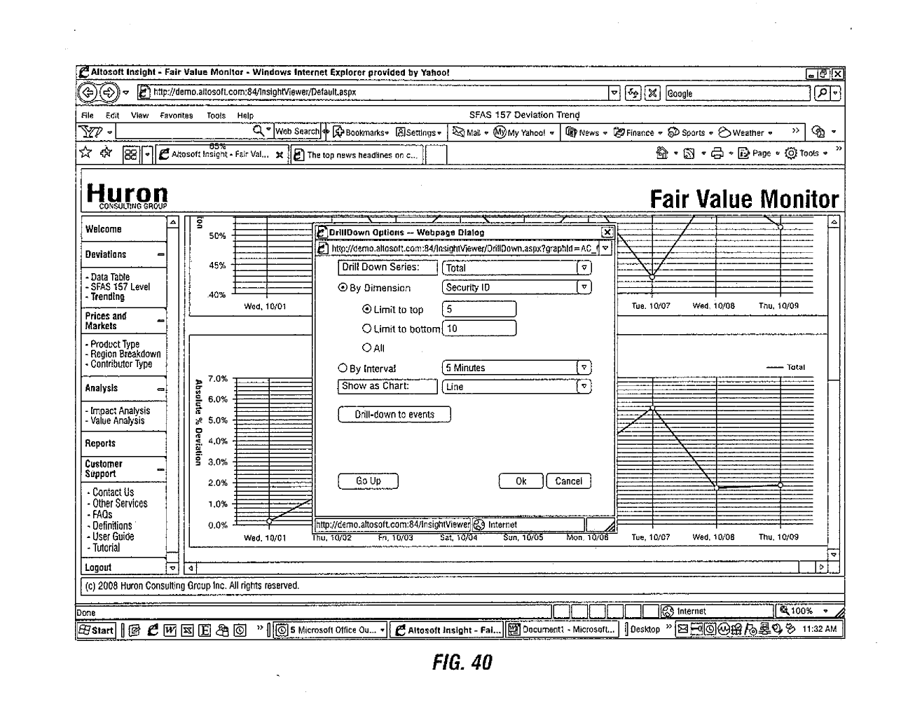

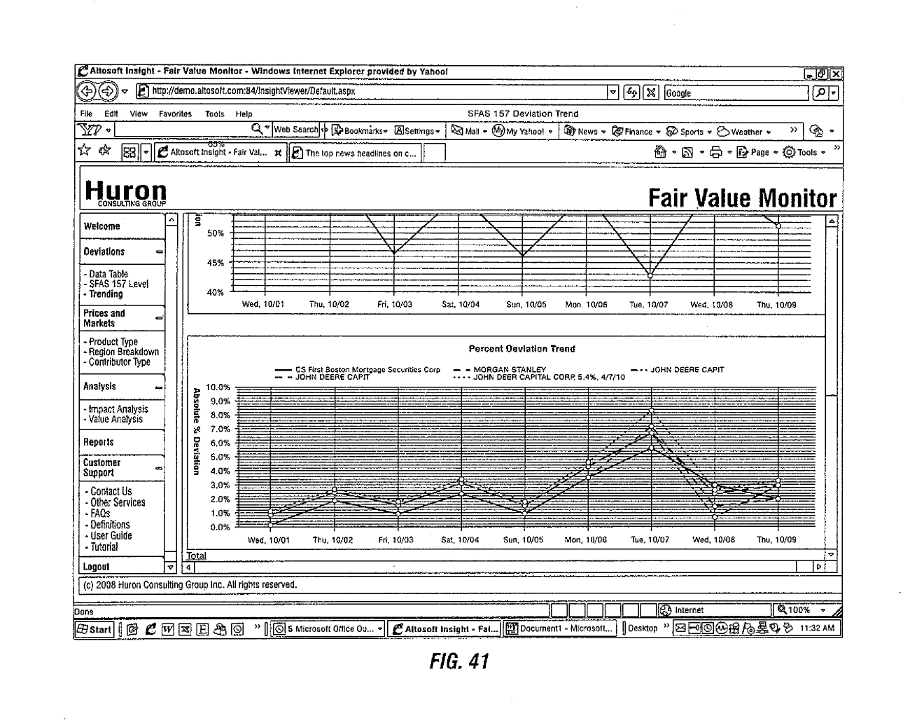

Selecting “trending” at 242 of FIGS. 32 through 34 displays three graphs. The first graph 244 is a trend analysis graph displaying the average number of standard deviations the user's portfolio pricing is from the mean price over a date range specified by the user. In an illustrative embodiment the price range can be changed using the date range tool located adjacent the graph. The second graph 246 of FIG. 33 is a trend analysis displaying the average percentage of FSAS 157 disclosure deviation between the user's portfolio and all other contributors over a date range specified by the user. The third graph 248 of FIG. 34 is a trend analysis graph displaying the average absolute price deviation between the user's portfolio and all other contributors over a date range specified by the user. As shown in FIG. 35, to specify the date range used in each of the three trend analysis graphs, the user may activate link 250 located adjacent the graphs. A dialog box 252 will appear allowing the date ranges to be entered. In an illustrative embodiment, and shown in FIG. 36, a calendar icon can be selected to provide the user with the ability to select dates from a calendar graphic 254. Selecting specific date ranges can change the graph range as indicated in FIG. 37. Similar to the functionality of the graphs from the data table and the SFAS 157 Levels, clicking on any line in these graphs provide the user with a “drill down” tool 260 to modify the underlying supporting data, as shown in FIG. 38. In the instance shown, the user has chosen to create a graph that charts each product type. The resulting graph 262 of FIG. 39, displays the standard deviation trend for each product type. Alternatively, and as shown in FIG. 40, the user has chosen to create a graph showing the securities with the five largest absolute price deviations. The resulting graph is displayed in FIG. 41.

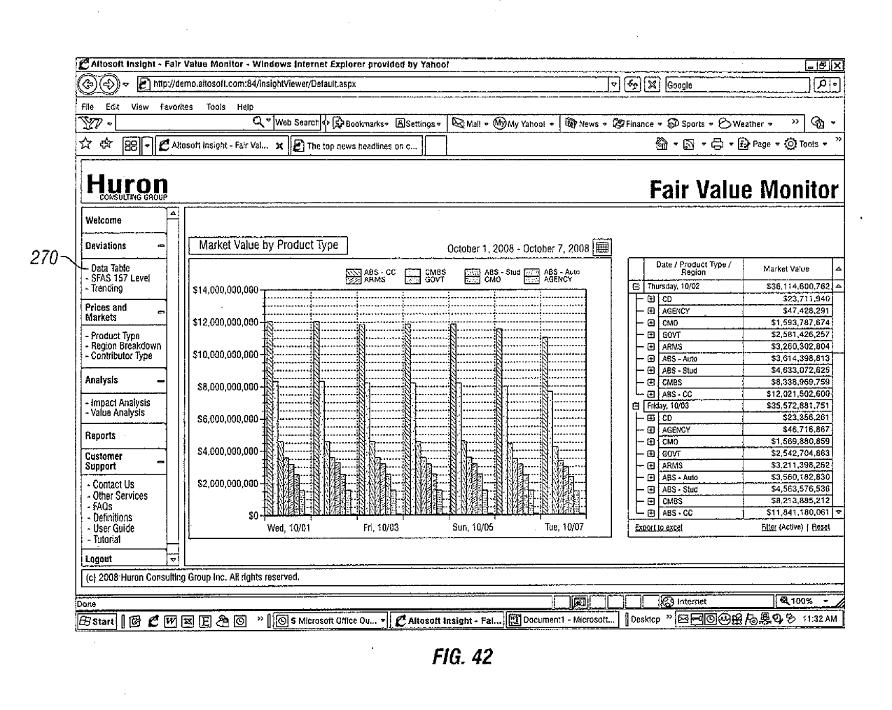

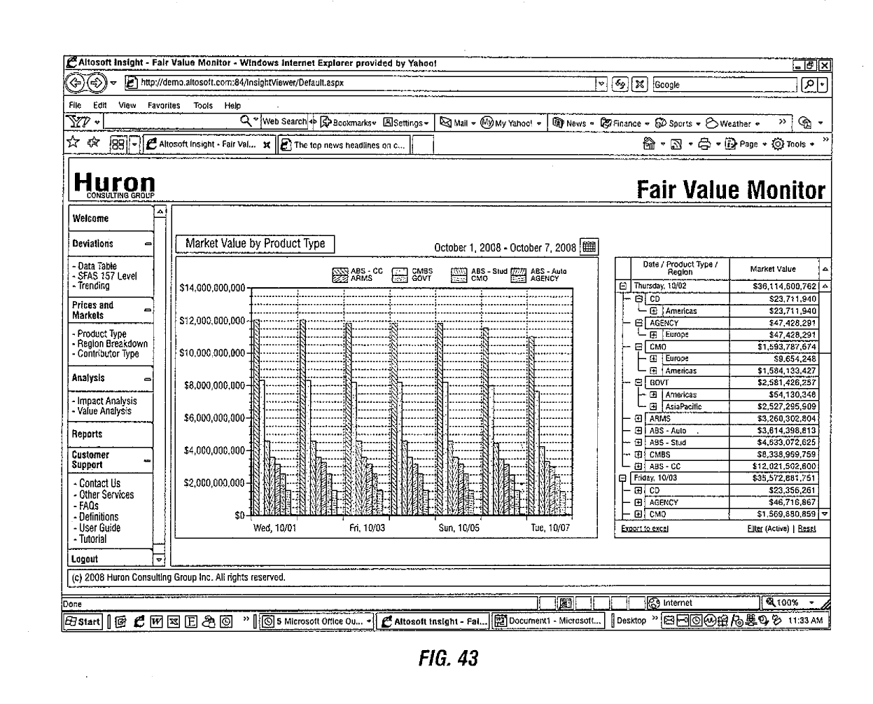

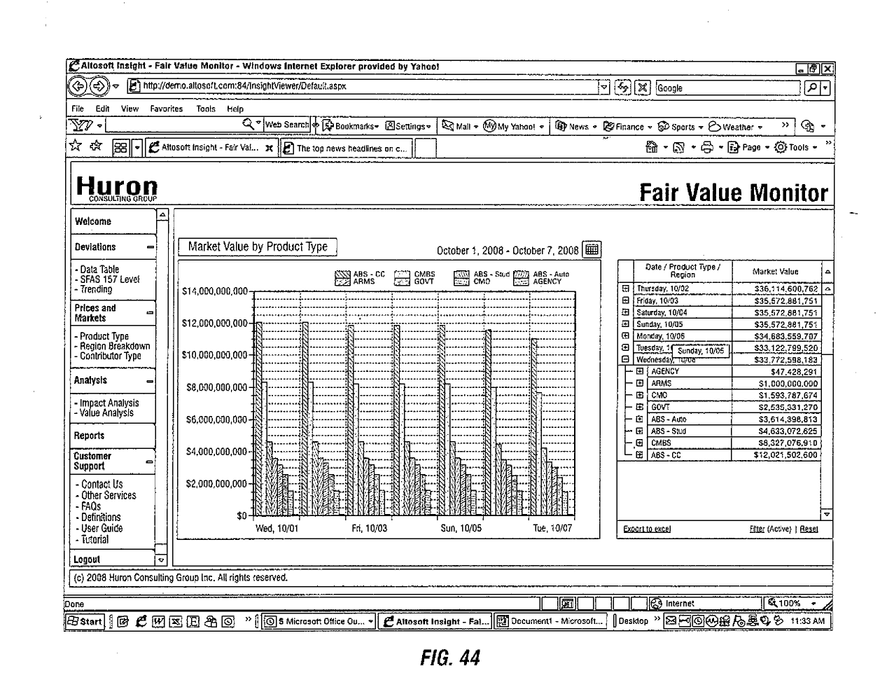

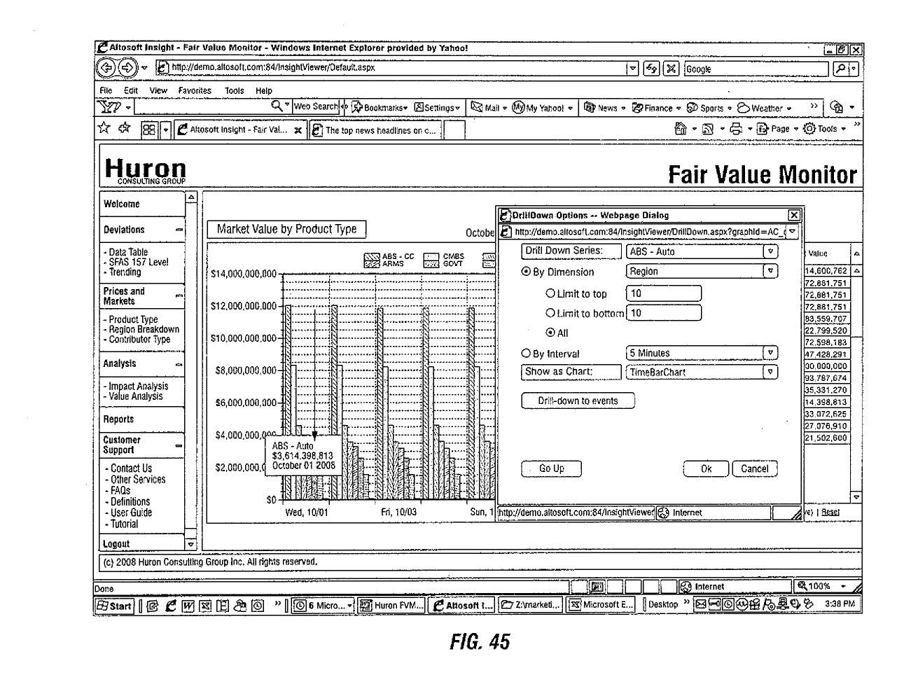

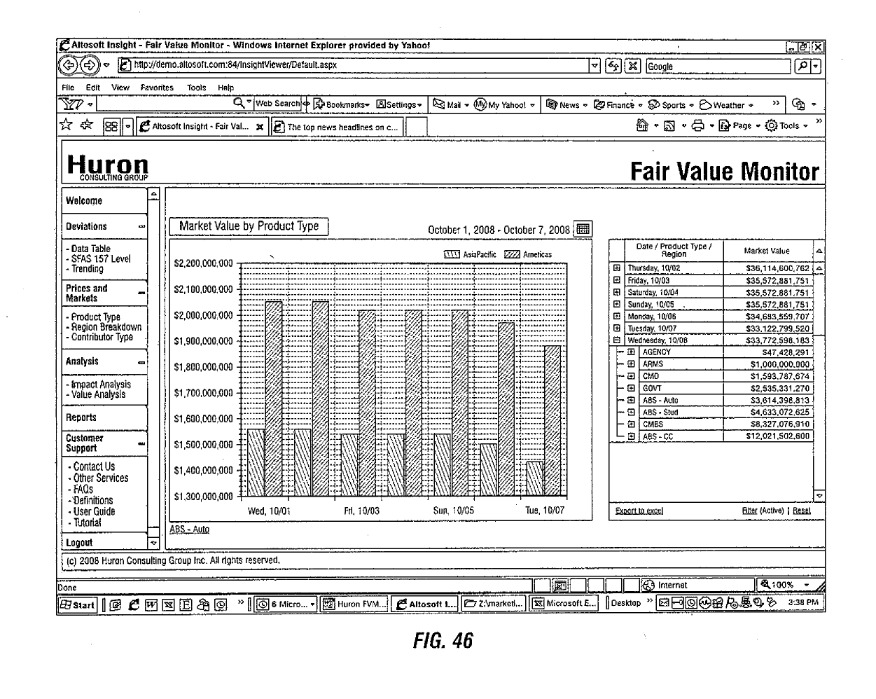

Selecting “Product Type” 270 of FIG. 42, brings the user to a screen displaying a graph and a data table containing a summary of the total market value of the securities by product type for each date uploaded by the user within the date range selected. The data table contains a summary of all securities by date. The securities have also been aggregated into the following grouping order: date, product type, region, and security description/ID. The detail supporting each group can be hidden or viewed by clicking conventional −/+ symbols, for example. In the instance shown in FIG. 43, the user has hidden the region detail supporting the CD, agency, CMO, and government product types included in the security portfolio dated 10/02. FIG. 44 shows that the user has hidden all but the product type information for Wednesday 10/08. FIG. 45 shows the user creating a graph (shown in FIG. 46) depicting the total market value for ABS-Auto, displayed by region.

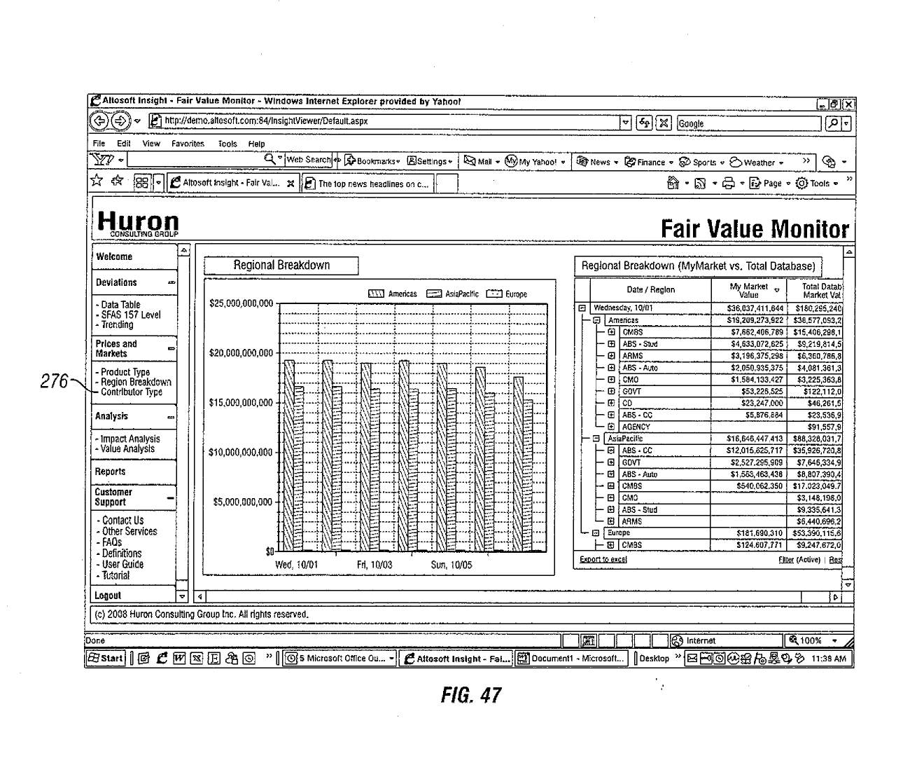

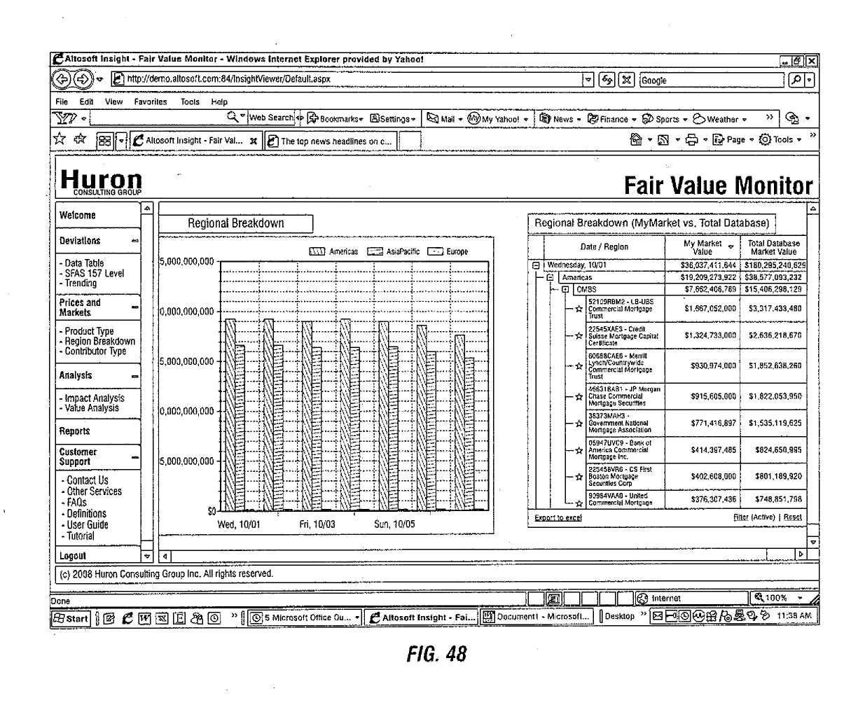

Selecting “region breakdown” 276 of FIG. 47 navigates the user to a screen that displays a graph and a data table (similar in type to those found in the “product type” tab) containing a summary of the total market value of the securities, by region, for each date uploaded by the user with the date range selected. Similar to that previously discussed, this data table contains a summary of all securities by pricing date. The securities have been aggregated into the following grouping order: date, region, product type, and security description/ID. As also previously discussed, the detail supporting each group total can be hidden or viewed by clicking on the −/+ symbols, for example. As shown in FIG. 48, the user has unhidden security description information for all data uploaded on 10/01 for product type CMBS in the Americas.

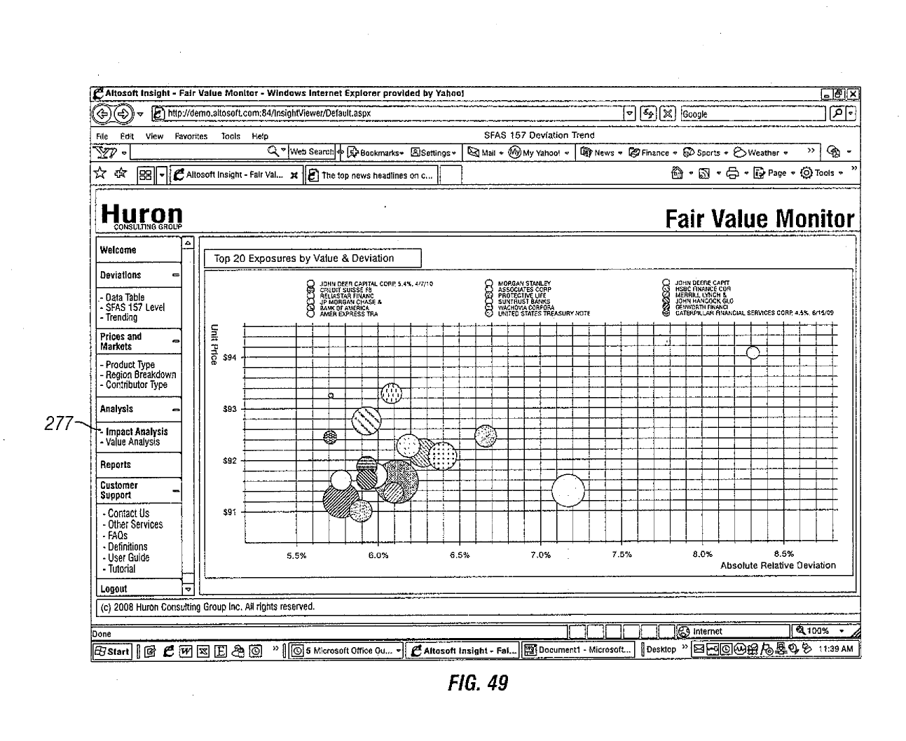

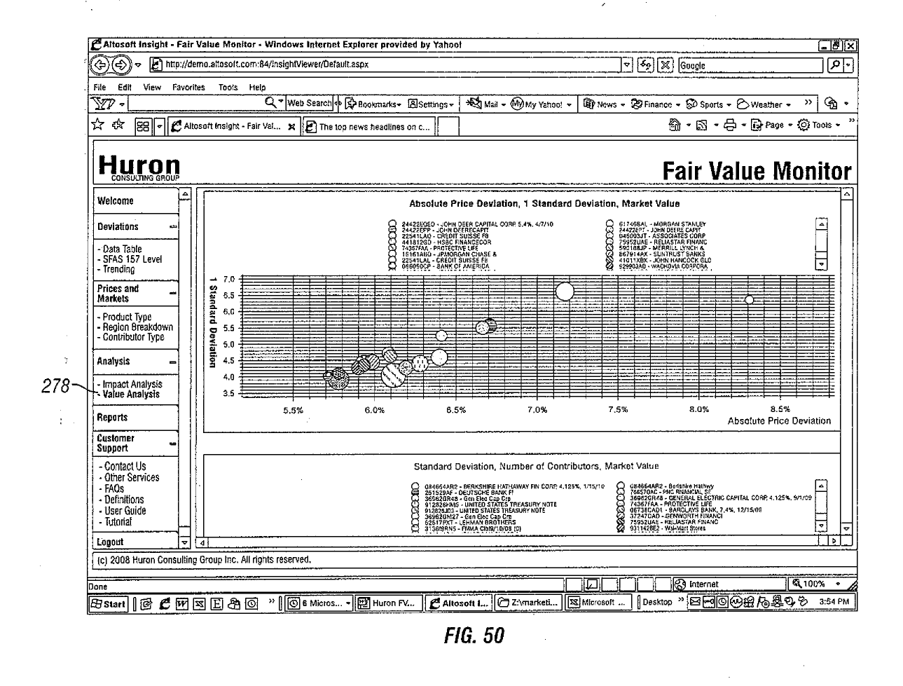

Selecting “impact analysis” at 277 as shown in FIG. 49, creates a graph showing the securities with the top 20 largest absolute price deviations. The securities are plotted against unit price (Y axis), absolute price deviation (X axis), and the market value (bubble size). Selecting “value analysis” 278, as shown in FIG. 50, displays new graphs. Each graph displays data based on distinct axes. The first graph is based on absolute price deviation, 1 standard price deviation, and market value. The second graph is based on standard deviation, number of contributors, and market value.

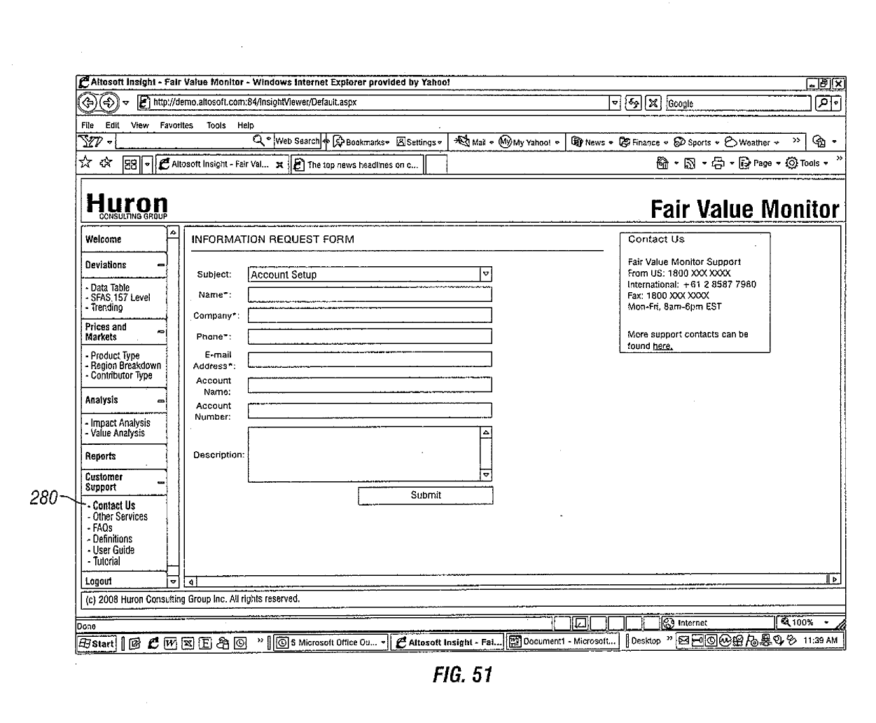

In an illustrative embodiment as shown in FIG. 51, selecting “contact us” 280 navigates the user to a form that can be filled out to submit information requests via email to the program administrator.

The following terms used herein are provided to assist those, including those not necessarily skilled in the art, to understand this disclosure. They are provided for assistance and illustrative purposes. Their inclusion is not an attempt or concession to limit the disclosure.

Standard Deviation—measure of the dispersion of unit prices provided by all contributors.
Sigma High—the high unit price is calculated as two standard deviations distance higher than the mean unit price. Under normal price distribution theory no more than the 2.1% of contributors would be expected to price an asset's value above this threshold.
Sigma Low—the low unit price is calculated as two standard deviations distance lower than the mean unit price. Under normal price distribution theory no more than 2.1% of contributors would be expected to price an asset's value below this threshold.
ABS-Auto—an asset-back security whose cash flows are derived from auto loans and/or leases.
ABS-CC—an asset-backed security whose cash flows are derived from credit card receivables.
Absolute Price Deviation—percentage deviation of “mind market price” from the weighted average mean market price. Calculated as price variance (my market price minus the weighted average mean price) divided by weighted average mean market price.
ABS-Stud—an asset-backed security whose cash flows are derived from student loan receivables.
Asset-Back Security—a security that is primarily serviced by the cash flows from a discreet pool of receivables or other financial assets, provided it meets the conditions outlined in 37 C.F.R. §29.1101.
Certificate of Deposit (CD)—certificate of deposit; short or medium term, interest bearing, FDIC-insured debt instrument offered by banks and savings and loans.
CMBS—a Commercial Mortgage-Backed Security is a type of mortgage-backed security backed by commercial mortgages rather than residential mortgages. They are comprised of a variety of loans each of which represents different property sizes and locations. These loans are pooled and broken into tranches of risks that are sold to investors.
Collateralized Mortgage Obligation (CMO)—is a mortgage-backed investment grade bond that separates mortgage pools into different maturity classes. Collateralized Mortgage Obligations are backed by mortgage backed securities with a fixed maturity.
CMO Agency—securities that are issued by Ginnie Mae, Fannie Mae, Freddie Mac, or other federal home loan banks. These securities are backed by mortgage loans and due to their creation from these particular corporations sponsored by the U.S. government, they enjoy credit protection based on an explicit guarantee from the U.S. government.
CMO-Arms—an Adjustable Rate Mortgage is a mortgage loan where the interest rate on the note is periodically adjusted based on a variety of indexes.
Coupon—the stated interest rate on the security when it was issued.
Face Amount—the nominal value or dollar value of a security stated by the issuer. For debt instruments it is the amount paid to the holder at maturity. Also known as “par value” or simply “par.”
Factor—a pool factor is a number expressed as a factor of one that is used to indicate the remaining principal balance of a note.
Fitch—current Fitch rating.
Issue Date—date security was issued.
Issue/Security—name of entity issuing security.
Market Value—current market value of open contracts at period end. Market value is equal to market price multiplied by quantity.
Maturity Date—date security matures.
Max Price 130—the highest unit price provided based on all other contributors excluding price contributed by the user.
Mean Price 128—the mean price of an asset is weighted by market value of contributor. Weighted mean price is calculated by dividing total market value of asset by total units.
Median Price—the middle unit price provided by contributors.
Min Price—the lowest unit price provided based on all other contributors excluding price contributed by the user.
Moody's—current Moody rating.
Number of Contributors—total number of contributors who have provided pricing information or a count of the prices submitted by contributors.
S&P—current S&P rating.
Security ID—unique identifier assigned to the security typically represents a 12 digit ISIN or 9 digit CUSIP number.
Issue Date—date security was issued.
Issuer/Security—name of entity issuing security.
Market Value—current market value of open contracts at period end. Market value is equal to market price multiplied by quantity.
Maturity Date—date security matures.
Max Price—the highest unit price provided based on all other contributors excluding price contributed by the user.
Mean Price—the mean price of asset is weighted by market value of contributor. Weighted mean price is calculated by dividing total market value of assets by total units.
Median Price—the “middle” unit price provided by contributors.
Min Price—the lowest unit price provided based on all other contributors excluding price contributed by user.
SFAS 157 Deviation—count of contributors utilizing SFAS 157 Level other than the SFAS 157 Level utilized by user divided by number of contributors.
SFAS 157 Level—contributor's classification of an asset's fair value hierarchy level as defined by Statement of Accounting Financial Standard 157.
Standard Deviation—calculated as price variance divided by one standard deviation. The number of standard deviations of the user price is from the mean price.
Total Market Value—contributor's calculation of total market value of an asset.
Unit Price—price of asset is calculated by dividing “total market value” by “units.”

Although the present disclosure has been described with reference to particular means, materials, and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A computer-based method to enable users to comparatively monitor a fair value for a security, the method comprising the steps of:
providing a computer configured to receive a data file of securities information that includes identity of security, identifier, market value, par value/shares, SFAS 157 Level disclosure, from a network, wherein the computer performs the steps of:
verifying the data file to confirm proper type of characters in each field of the data file are being used, pricing being limited to a predetermined date range, no zero or null values in each field, and reviewing outlier data;
displaying a warning for rejected data and acceptance notice for accepted data;
uploading accepted data from the data file to the computer;
merging accepted data from the data file with corresponding data provided by other contributors relevant to the security to create merged data;
displaying a notice when merging is complete;
analyzing the merged data to create key performance indicators including absolute price deviation, standard deviation, minimum price, maximum price, mean price, median price, 2 sigma low, 2 sigma high, 1 standard deviation 118, measure of the dispersion of Unit Prices provided by all contributors;
creating a data table of securities from the data files uploaded to the computer, wherein the data table identifies the number of other contributors, SFAS 157 Level, SFAS 157 deviation and key performance indicators;
filtering out identities of names of contributors to keep source of securities pricing information anonymous;
calculating percentage of contributors who have selected SPAS 157 Levels other than the SFAS 157 Level disclosed in the upload;
selectively creating a report selected from a group consisting of deviations, price and markets, and analysis;
wherein the deviations report comprises statistical fair value evaluation, SFAS 157 Level, and trend analysis categories;
wherein the prices and markets report comprises market value by product type, regional breakdown, and contributor type categories;
wherein the analysis report comprises default analysis and customizable value analysis categories;
creating user-manipulable reports from the key performance indicators
comparing user price paid to other valuations to gauge whether the particular valuation is a fair value.

2. The computer-based method to monitor the fair value for a security of claim 1, wherein the resulting data table includes a listing of securities submitted by others that is more than 2% greater than a weighted average mean of prices uploaded by other contributors.

3. The computer-based method to monitor the fair value for a security of claim 1, further comprising the step of selectively filtering at least one key performance indicator.

4. The computer-based method to monitor the fair value for a security of claim 1, further comprising the step of selectively exporting the data table to a spreadsheet program.

5. The computer-based method to monitor the fair value for a security of claim 1, further comprising the step of graphing an average absolute price deviation for each security type based on an aggregation of contributed prices.

6. The computer-based method to monitor the fair value for a security of claim 1, further comprising the step of filtering the data table to limit the securities displayed in the table to meet user specified criteria.

7. The computer-based method to monitor the fair value for a security of claim 1, further comprising the step of calculating and plotting a trend analysis that is selected from a group consisting of standard deviation trend, SFAS 157 deviation trend, percent deviation trend.

8. The computer-based method to monitor the fair value for a security of claim 7, wherein the percent deviation is an average absolute price deviation between a user's portfolio and all other contributors over a date rage specified by the user.

9. The computer-based method to monitor the fair value for a security of claim 1, further comprising the step of creating customized positions and pricing breakdowns selected from a group consisting of contributor type, region, product type, date, and security description.
